(19) United States
(12) Patent Application Publication
(10) Pub. No.: US 2025/0356195 A1
(43) Pub. Date: Nov. 20, 2025

(54) Responsible Machine Learning for Safety Assessment and Planning in Data Networks

(71) Applicant: Fair Isaac Corporation, Minneapolis, MN (US)

(72) Inventors: Scott ZOLDI, San Diego, CA (US); Jeremy SCHMITT, Encinitas, CA (US); Qing LIU, San Diego, CA (US); Thomas QUINN, San Francisco, CA (US); Paul PANICHELLI, Holly Springs, GA (US); Prasanth GOPINATHAN, Pleasanton, CA (US); Steven HU, San Jose, CA (US); Thomas LEE, Hercules, CA (US)

(21) Appl. No.: 19/181,207

(22) Filed: Apr. 16, 2025

Related U.S. Application Data
(63) Continuation-in-part of application No. 19/022,858, filed on Jan. 15, 2025.
Application No. 19/022,858 is a continuation of application No. 17/121,594, filed on Dec. 14, 2020, now Pat. No. 12,236,353.

(51) Int. Cl. G06N 3/088; G06N 3/045

(52) U.S. Cl. CPC G06N 3/088; G06N 3/045

(57) ABSTRACT

Computer-implemented systems, products, and methods for receiving data characterizing a set of user-define parameters from a first entity including at least a target assessment rating and a target time duration; simulating, based on the received data, one or more scenarios, wherein each of the one or more scenarios is associated with a set of action items; determining a total score for each set of action items for each scenario; removing, using an analytic decision tree, any scenario from the one or more scenarios that includes a total score that fails to satisfy a set of predetermined criteria; determining an efficiency factor associated with each of the one or more remaining scenarios; and providing the remaining one or more scenarios in a hierarchical position based on the efficiency factor.

### RELATED APPLICATIONS

This Application is a Continuation-in-Part of and claims priority to the earlier effective filing dates of the following: U.S. patent application Ser. No. 19/022,858, filed on Jan. 15, 2025 [Att. Docket 035006-830C01US], which claims the benefit of U.S. patent application Ser. No. 17/121,594, filed on Dec. 14, 2020 [Att. Docket 035006-830F01US]. The contents of these applications are hereby incorporated by reference herein in entirety.

### TECHNICAL FIELD

The disclosed subject matter generally relates to artificial intelligence technology and, more particularly, to machine learning (ML) systems adapted for assessment and planning in data networks.

### BACKGROUND

Artificial intelligence (AI) refers to introducing humanlike logic or intuition in a computing system. AI is commonly used to perform tasks that require intelligence or domain expertise which help solve problems that cannot be defined by a predetermined set of rules or fixed logic. AI systems are thus typically deployed to analyze and classify data and make predictions relying on data and dynamic calculations that are far too voluminous and complex for a human to possibly digest and perform, either mentally or by way of pen and paper.

Machine learning (ML) is a subset of AI that utilizes self-learning models and strategies to implement intelligent behavior into AI systems and generally refers to the practice of teaching a computing system to learn, including the ability to dynamically adapt and analyze large volumes of data to identify patterns, without requiring explicit programming. Unconventionally, ML models may provide predictive advantages to enhance the functionality of a system or a computing model when complex relationships or constraints are at play.

Disadvantageously, without a good understanding of the influences, relationships, or constraints that define a ML model, the ML model's latent or non-routine functionality and behavior may be prone to errors or undesirable biases that may not meet certain principles or standards. For example, a lack of complete understanding of a model's behavior may lead to scenarios involving the encoding of unintentional or unwanted features that inappropriately or unknowingly skew the results generated by the model.

ML models may be utilized to enhance the functionality of assessment systems. In a conventional assessment system, a simplified assessment rating is generated based on many assessment factors to provide a quick and easy understanding of the classification or state of an entity, event, or operation. An assessment rating may be generated or manifested in the form of a score, a classification score, a morbidity score, a data corruption score, a credit score, etc. It may be desirable to determine whether one or more actions may be taken to improve an assessment rating, especially when it is uncertain exactly how the assessment factors influence the generated rating.

As an example, in the case of an assessment rating or score calculated for an individual or entity, it may be unknown how the score was calculated and what may be done to improve the score for that particular individual or entity. Depending on implementation, the model utilized to generate the score may have been configured to give certain factors more weight than other factors. A better understanding of factors that most impact the generated score is highly desirable but is not readily possible in conventional systems.

It is further desirable to easily determine and view, in a simplified user interface, the sets of actions that may be taken to potentially improve or favorably increase the score without the need to go through a tedious set of steps or knowledge bases or drilling through multiple layers of user interfaces. The conventional systems, typically, require extensive user interaction or knowledge of the underlying features in order to provide suggestions about how the score may be improved. This is burdensome, confusing, and impractical and cannot be performed in the human mind or by pen and paper.

As such, suggestions provided by the conventional technologies are often difficult to follow and view as they require a tedious process to sift through multitudes of different options, programs, pages, and interfaces. Even so, in the end, one may still not be able to easily determine what the best options are or which particular action items are best suited to achieve an end goal. Further, in the conventional systems, achieving a desired score may not be materially possible or practical or may take a long time if proper suggestions are not offered or proper actions are not taken.

It would be useful to know what possible action items can be followed to most optimally achieve a particular objective by a target time period. In other words, if certain steps are too burdensome or do not substantively result in reaching the desired objective, then it would be beneficial to instead know how to pursue other action items that are more practical. Moreover, conventional technologies fail to suggest in a meaningful order actions that may be taken to best achieve an objective. Solutions are needed to address the noted shortcomings.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a computer-implemented system and method is provided for displaying, on a display screen, a graphically implemented interactive menu listing a plurality of user interface fields. The plurality of user interface fields receive a set of user-define parameters from a first entity including at least a target assessment rating and a target time duration. Based on at least the target assessment rating and the target time duration, a first weight matrix is generated by using a first artificial neural network (ANN) associated with an aggregate dataset.

In certain aspects, the first weight matrix includes a set of weighted score factors related to the first entity. By the first ANN, one or more scenarios are simulated for a set of action items by evaluating an analytic decision tree using the first weight matrix. Based on the simulation, a first scenario associated with a first planning statement and a first set of corresponding action items, and a second scenario associated with a second planning statement and a second set of corresponding action items, are determined, wherein the first scenario achieves one or more favorable outcomes, in terms of achieving at least a first assessment rating within a first timeline, over the second scenario.

In some embodiments, the first scenario is ranked in a more elevated hierarchical position than the second scenario based on the one or more favorable outcomes. At least the first planning statement and the first set of corresponding action items are generated for display on the display screen, based on the elevated hierarchical position of the first scenario. The second planning statement and the second set of corresponding action items may be generated for display based on a less elevated hierarchical position of the second scenario, wherein the second set of action items is more burdensome than the first set of action items, such that the first set of action items are presented in advance of the second set of action items on the display screen.

One or more action items in the first set of action items represent one or more actions that may be taken to achieve a target assessment score by a suggested time duration associated with the target time duration, the one or more actions being associated with at least one of the weighted score factors, wherein the suggested time duration matches the target time duration. Depending on implementation, the suggested time duration may be shorter than the target time duration, in response to determining that the target assessment rating is achievable in a shorter timeframe than the target time duration.

In certain aspects, the suggested time duration is longer than the target time duration, in response to determining that the target assessment rating is unachievable in the target time duration. A less desirable target assessment rating than the target assessment rating may be suggested in the planning statement, in response to determining that the less desirable target assessment rating, instead of the target assessment rating, is achievable in approximately the target time duration.

In accordance with alternative embodiments, a primary computing device comprising a display screen is provided, wherein the primary computing device configured for displaying on the display screen, using a processor, a graphically implemented interactive menu listing a plurality of user interface fields, at least one user interface field displayed on the display screen being directly reachable from the interactive menu to receive a set of user-defined parameters, including at least one of a target score and a target time duration, wherein the interactive menu, using the processor, displays a limited list of data including value of at least one of the target score or the target time duration in one or more user interface fields.

In certain aspects, the target score or the target time duration is utilized by the processor to execute an application to enable displaying a set of action items in a hierarchical order, wherein the interactive menu is displayed while the application is in a first state associated with receiving the set of user-defined parameters, the application, using the processor, utilizing an analytic decision tree to simulate one or more scenarios for a set of action items that improve a score at a first time towards the target score by the target time duration, in response to the processor determining that the target score or the target time duration are within an acceptable range, in response to the application being executed by the processor, the application accessing data associated with a first entity, the data generated based on a set of weighted score factors related to the first entity's creditworthiness.

In some embodiments, using the processor, the interactive menu is generated including at least one of a first field displaying a first score, a second field for receiving and displaying the target score, and a third field for receiving and displaying the target time duration. The target time duration indicates a period of time starting from the first time until a second time after the first time for achieving the target score, as the first score changes over time based on changes in values of one or more score factors in the set of weighted score factors. The application, in response to receiving the target score and the target time duration via the interactive menu, simulates using the processor a plurality of scenarios that satisfy the target score within the target time duration.

In at least one aspect, the following are scenarios are simulated: a first scenario associated with a first plurality of possible planning statements and a first set of action items, a second scenario associated with a second plurality of possible planning statements and a second set of action items. The application, in response to determining that the first scenario achieves a more favorable result in terms of a combination of wait time and score improvement over the second scenario, orderly ranks the first scenario in a more elevated hierarchical position than the second scenario using the processor. The first plurality of possible planning statements and the first set of action items are generated for display on a display screen based on the elevated hierarchical position of the first scenario, wherein the first set of action items is less burdensome than the second set of action items.

In some embodiments, the second plurality of possible planning statements and the second set of action items are generated for display on the display screen based on a less elevated hierarchical position of the second scenario, wherein the second set of action items is more burdensome than the first set of action items, such that the first set of action items is presented in advance of the second set of action items on the display screen. One or more action items in the first set of action items may represent one or more actions that may be taken to achieve the target score by a suggested time duration associated with the target time duration, the one or more actions being associated with at least one of the weighted score factors, wherein a less desirable target score than the target score is suggested in the planning statement, in response to the processor determining that the less desirable target score, instead of the target score, is achievable in approximately the target time duration.

In accordance with one or more aspects, the suggested time duration matches the target time duration. The suggested time duration may be shorter than the target time duration, in response to determining that the target score is achievable in a shorter timeframe than the target time duration. The suggested time duration may be longer than the target time duration, in response to determining that the target score is unachievable in the target time duration.

In other example embodiments, a computer-implemented method is provided, where the method comprises receiving, by an application specific integrated circuit (ASIC) for a first artificial neural network (ANN), a set of user-define parameters from a first entity including at least a target assessment rating and a target time duration; generating, based on at least the target assessment rating and the target time duration, a first weight matrix by using the first ANN, the first weight matrix includes a set of weighted score factors related to the first entity; simulating, by using a first hidden node associated with the first ANN, one or more scenarios for a set of action items by evaluating an analytic decision tree using the first weight matrix; and determining, by using the ASIC and based on the simulation, a first scenario associated with a first planning statement and a first set of corresponding action items, and a second scenario associated with a second planning statement and a second set of corresponding action items.

Depending on implementation, the first scenario achieves one or more favorable outcomes, in terms of achieving at least a first assessment rating within a first timeline, over the second scenario. The method may further comprise ranking the first scenario in a more elevated hierarchical position than the second scenario based on the one or more favorable outcomes; and generating, by using the ASIC and responsive to the ranking, the first planning statement and the first set of corresponding action items based on the elevated hierarchical position of the first scenario. Responsive to the ranking, the second planning statement and the second set of corresponding action items may be generated based on a less elevated hierarchical position of the second scenario, wherein the second set of action items is more burdensome than the first set of action items.

In some embodiments, one or more action items in the first set of action items represent one or more actions that may be taken to achieve a target assessment score by a suggested time duration associated with the target time duration, the one or more actions being associated with at least one of the weighted score factors. In one aspect the suggested time duration matches the target time duration. In other aspects, the suggested time duration is shorter than the target time duration, in response to determining that the target assessment rating is achievable in a shorter timeframe than the target time duration, or the suggested time duration is longer than the target time duration, in response to determining that the target assessment rating is unachievable in the target time duration. Depending on implementation, a less desirable target assessment rating than the target assessment rating may be suggested in the planning statement, in response to determining that the less desirable target assessment rating, instead of the target assessment rating, is achievable in approximately the target time duration.

In accordance with one or more embodiments, a method of rearranging a plurality of icons on a graphical user interface (GUI) of a computer system is provided, wherein the plurality of icons are associated with a plurality of simulated scenarios for achieving a target assessment rating by a target time duration. The method comprises receiving, via a GUI, a selection to organize the plurality of icons based on a specific criteria, wherein the specific criteria is an amount of burden determined for a simulated scenario; determining, by a processor, the amount of burden for at least two or more of the plurality of scenarios, wherein the amount of burden is based on one or more action items suggested by a simulated scenario for best achieving the target assessment rating by the target time duration or a time within a threshold distance from the target time duration; automatically moving the icons associated with the plurality of simulated scenarios to positions on the GUI according to a hierarchical arrangement determined based on the respective amounts of burden determined for the plurality of simulated scenarios.

In accordance with one or more embodiments, another method of rearranging a plurality of icons on a graphical user interface (GUI) of a computer system is provided, wherein the plurality of icons are associated with a plurality of simulated scenarios for achieving a target assessment rating by a target time duration. The method comprises receiving, via a GUI, a selection to organize the plurality of icons based on a specific criteria, wherein the specific criteria is a preference value or an amount of efficiency determined for a simulated scenario; determining, by a processor, the preference value or the amount of efficiency for at least two or more of the plurality of scenarios, wherein the preference value or the amount of efficiency is based on one or more action items suggested by a simulated scenario achieving the target assessment rating by the target time duration; automatically moving the icons associated with the plurality of simulated scenarios to positions on the GUI according to a hierarchical arrangement determined based on the respective preference values or amounts of efficiency determined for the plurality of simulated scenarios.

In accordance with one embodiment, a computer-implemented method is provided, the method comprising receiving data characterizing a set of user-define parameters from a first entity including at least a target assessment rating and a target time duration; simulating, based on the received data, a plurality of scenario constructs, wherein at least a first scenario construct from among the plurality of scenario constructs is associated with a first set of action items and at least a second scenario construct from among the plurality of scenario constructs is associated with a second set of action items; determining a first burden value for the first scenario construct and a second burden value for the second scenario construct; determining suitability of the plurality of scenarios based on the burden values respectively associated with the plurality of scenario constructs; and providing one or more scenario constructs in the hierarchical order based on the respective burden values.

In accordance with another embodiment, a computer-implemented method is provided, the method comprising receiving data characterizing a set of user-define parameters from a first entity including at least a target assessment rating and a target time duration; simulating, based on the received data, one or more scenario constructs, wherein each of the one or more scenario constructs is associated with a set of action items; determining a total score for each set of action items for each scenario construct; removing, using an analytic decision tree, any scenario construct from the one or more scenario constructs that includes a total score that fails to satisfy a set of predetermined criteria; determining an efficiency factor associated with each of the one or more remaining scenario constructs; and providing the remaining one or more scenario constructs in a hierarchical position based on the respective efficiency factors.

A computer-implemented method, in some embodiments, may comprise receiving data characterizing a set of user-define parameters from a first entity including at least a target assessment rating and a target time duration; simulating, based on the received data, a plurality of scenarios, wherein at least a first scenario from among the plurality of scenarios is associated with a first set of action items and at least a second scenario from among the plurality of scenarios is associated with a second set of action items; determining a first simulated score and a first burden value for the first scenario and a second simulated score and a second burden value for the second scenario; determining suitability of the plurality of scenarios based on the simulated score and the burden values respectively associated with the plurality of scenarios; determining a distance between the target assessment rating and the simulated score corresponding to a set of action items; and providing one or more scenarios that include a distance that satisfies a predefined threshold, wherein the one or more scenarios are provided in a hierarchical order based on the burden values.

A computer-implemented method, in some other embodiments, may comprise receiving data characterizing a set of user-define parameters from a first entity including at least a target assessment rating and a target time duration; simulating, based on the received data, one or more scenarios, wherein each of the one or more scenarios is associated with a set of action items; determining a total score for each set of action items for each scenario; removing, using an analytic decision tree, any scenario from the one or more scenarios that includes a total score that fails to satisfy a set of predetermined criteria; determining an efficiency factor associated with each of the one or more remaining scenarios; and providing the remaining one or more scenarios in a hierarchical position based on the efficiency factor.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates components of an example machine learning model, in accordance with one or more implementations.

FIG. 2 is a diagram of an example aggregate data set and sliced data sets, in accordance with one or more implementations.

FIG. 3 is a diagram of an example artificial neural network, in accordance with one or more implementations.

FIG. 4 is a diagram of transfer learning between an aggregate neural network and a slice neural network, in accordance with one or more implementations.

FIG. 5 is a diagram of the aggregate neural network and the slice neural network calculating and generating a latent misalignment score, in accordance with one or more implementations.

FIG. 6 is a graph diagram illustrating misalignment scores for different slices of data, in accordance with one or more implementations.

FIG. 7 is a flowchart of an example process for identifying misalignment in a latent space of a machine learning model.

FIG. 8 illustrates a computing environment that supports an assessment rating system (e.g., a score planner), in accordance with one or more embodiments.

FIGS. 9A, 9B, and 9C are illustrations of example user interfaces for assessment score planning, in accordance with different embodiments.

FIG. 10A is a generalized example flow diagram of a method for assessment score planning, in accordance with one or more embodiments.

FIG. 10B illustrates an example decision tree in accordance with one embodiment.

FIG. 10C is a flow diagram of an example process for generating one or more scenarios, planning statements, or action items, in accordance with one or more implementations.

FIG. 10D is a flow diagram of another example process for generating one or more scenarios, planning statements, or action items, in accordance with one or more other implementations.

FIGS. 11A through 11G are example illustrations of a user interface showing a variety of possible scenarios, planning statements, or action items displayed in an ordered arrangement, in accordance with one or more embodiments.

FIG. 12 depicts a block diagram illustrating an example computing apparatus consistent with implementations of the disclosed subject matter in one or more embodiments.

FIG. 13 illustrates example training and operating environments for a machine learning model, in accordance with one or more embodiments.

Where practical, the same or similar reference numbers denote the same or similar or equivalent structures, features, aspects, or elements, in accordance with one or more embodiments.

### DETAILED DESCRIPTION

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others. Decision management systems generally rely upon an underlying set of rules and models, which deliver one or more decisions that a user may leverage in pursuit of a desired outcome for a given input. Some decision management systems, including assessment rating models and planning systems, receive a multitude of data inputs to generate a broad range of possible outcomes, often in real-time. These systems require the efficient processing of complex high-value data streams to produce reliable and adaptive assessments ratings.

The development of a machine learning (ML) model in general involves considerations of a set of data available for training the model and whether subsets of the available data are appropriate for the decision process. While pooling data from different sources may be a powerful advantage for model training, it may also introduce hidden risks related to the underlying integrity of the model. One of the most impactful choices in a ML model development process is to decide which subsets of data to utilize. Further, it is inevitably important in production to continually re-evaluate the alignment of a specified input data source with the desired decision goal. Measuring the degree of misalignment of a given data source is a core tenant of responsible AI.

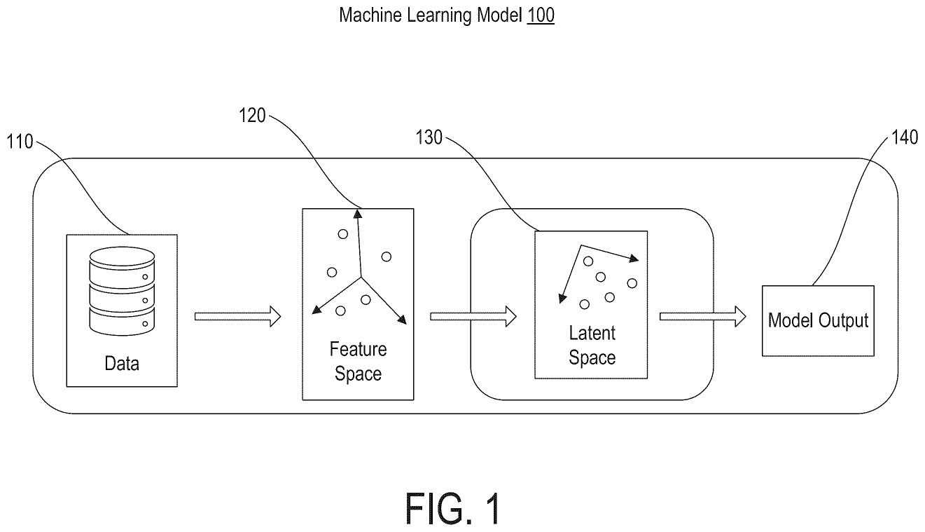

Referring to FIG. 1, an example ML model 100 is illustrated. As shown, ML model 100 includes a dataset 110, a feature space 120, a latent space 130, and a model output 140. ML model 100 may be implemented on a computing system, the computing system may be a general-purpose computer, for example, or any other suitable computing or processing platform. The computing system may include learning software (e.g., a machine learning or self-learning software) that receives dataset 110 as an input.

In accordance with one aspect, a group of datasets 110 are mapped into a collection of features that are inputs for ML model 100. This collection of features defines the feature space 120. The feature space 120 may be defined independently of ML model 100, although ML model 100 will be dependent upon the choice of feature space 120. ML model 100 transforms the features into latent variables that are directly used to produce the model output 140. The latent space 130 of a ML model 100 is defined by the set of latent variables, and is inherent to the underlying ML model 100. Implementations of the current subject matter provide a measure of misalignment for a given subset of data with respect to ML model 100 by measuring properties of the embedding in latent space 130.

Existing systems for measuring data alignment have focused primarily on alignment regarding the data used in the development of a ML model and the subsequent embedding of the generic data in feature space 120. Embodiments described herein may additionally leverage the knowledge in the ML model by analyzing misalignment in the latent space, thereby providing a measure of misalignment with respect to the ML model. Such a concept may be increasingly important in the view of responsible AI and humble AI.

Depending on implementation, if the data is not aligned with the latent space of the ML model, the ML model should not be used for customer scoring. Measurement systems described herein may provide two levels of misalignment: (i) latent feature misalignment with respect to a given ML model; and (ii) a relative misalignment among subsets of data. Therefore, this measure may be used to not only guide any subsets of data towards a more appropriate model, but also inform modelling choices to ensure sufficient generalization during model development.

In accordance with one or more embodiments, learning software may process the dataset 110 associated with certain features (e.g., individual measurable properties or characteristics of a phenomenon or the dataset 110 being observed). The features may define the feature space 120. As shown the feature space 120 may be processed to produce the latent space 130. The latent space 130 may be a compressed representation of the feature space. Latent space 130 may be useful for learning data features and for finding simpler representations of data (e.g., dataset 110) for analysis.

ML model 100 may transform latent variables in the latent space 130 to the model output 140. In some aspects, the generated model output 140 may indicate that the dataset 110 is classified as belonging to a certain class by the learning software. In one aspect, the model output 140 may be checked against an associated label to determine how accurately the learning software (e.g., a machine learning or self-learning software) is classifying the dataset 110.

The embodiments disclosed herein include measuring the alignment (or conversely, misalignment) of a subset of data (e.g., dataset 110) with respect to an existing ML model (e.g., ML model 100). A computerized implementation may be used to create an end-to-end software solution to obtain misalignment scores. The implementation may involve additional tuning of the ML model with an emphasis on the selected subset of data, which may result in a new ML model that is of the same class of model as the original ML model. Using various techniques to compare the two ML models provides a measure of change between these two ML models. Such a measure of change may then be referred back to the subset of data to indicate the degree of misalignment of the subset of data with respect to the original predictive model.

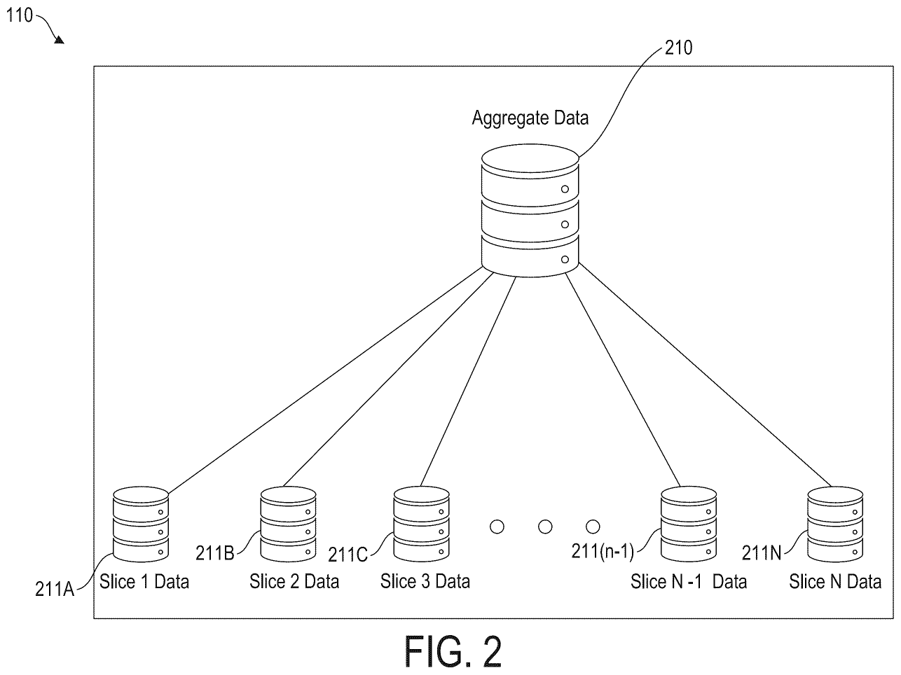

Aggregate data may be defined as a finite collection of subsets of data that all belong to the same feature space and target space (e.g., dataset 110), in the context of a supervised ML model. For example, each subset of data may correspond to data from a different institution or alternatively, to a sub-portfolio of data within one institution or more generally a proper subset of data from the aggregate data. Without loss of generality, a subset of data may be referred to as a data slice, a ML model trained on aggregate data may be referred to as an aggregate ML model, and a ML model trained on a data slice may be referred to as a slice ML model. In some aspects, the combined data from different data slices may result in the aggregate data (see FIG. 2), but the data slice need not have a non-empty intersection with the aggregate data.

Referring to FIG. 2, an example dataset 110 may include an aggregate dataset 210 and sliced datasets 211. In accordance with one or more implementations, the aggregate dataset 210 may be divided up among one or more subsets (e.g., slices 211). As shown, the aggregate dataset 210 includes an N quantity of data slices (e.g., 211A-211N), although other quantities of slices are also possible. In some implementations, the dataset 110 may include information associated with a profile (e.g., a data packet profile, a credit applicant profile, etc.) that may be used to train a ML model to generate an assessment rating (e.g., a data packet safety or morbidity score, an application score, a credit score, etc.).

As one example, in a communications network that is susceptible to the transmission of corrupt or malicious data packets, ML model 100 may be used to determine ratings associated with the transmitted data packets based on data stored in dataset 110. According to the rating associated with a data packet, ML model 100 may classify or identify the data packet as malicious. For example, a data packet may be classified as more or less likely to be malicious and associated with a safety score or a morbidity score. The data packet may be eliminated if either the safety score or the morbidity score is not within acceptable thresholds. Depending on a rating assessment associated with the data packets, a maximum number of malicious data packets may be blocked or dropped from transmission, while maintaining an acceptable transmission bandwidth or throughput.

As another example, in an environment in which various credit-related activities are monitored, ML model 100 may be trained using data stored in dataset 110 to generate an assessment rating (e.g., a score) for an individual or entity. To generate an assessment rating or score, an assessment system having access to historic data stored in dataset 110 may utilize ML model 100 to determine an individual's creditworthiness. To the extent that most ML models are proprietary and are not fully predictable, conventional credit planning technologies are only capable of providing generic recommendations based on a general understanding of known scoring models.

At best, these conventional technologies are only capable of suggesting action items about how a typical assessment rating may be improved. In other words, the conventional assessment rating and planning technologies only provide generic recommendations that are useful for typical scenarios, even if those recommendations are inapplicable or detrimental to atypical scenarios. Applying typical recommendations to atypical scenarios may be greatly detrimental. Therefore, improvements to the conventional assessment rating and planning technologies are needed to prevent detrimental results.

More specifically, the conventional assessment rating and planning technologies function without taking into consideration particular objectives or limitations. For example, the conventional assessment rating and planning technologies lack technical features for selecting or suggesting the best (e.g., the most practical or least burdensome) action items based on a set of many possible scenarios. No assessment rating and planning technology is currently available that can recommend a set of specific actions items that allow the achievement of certain specific objectives in the least burdensome manner.

Furthermore, the conventional assessment rating and planning technologies are incapable of providing custom recommendations based on multiple user-defined parameters. For example, a user is unable to set a target date by which to achieve a target score. Further, no conventional assessment rating and planning technologies provide an easily accessible interactive menu that is capable of accepting specific user-defined parameters and can, in response, adaptively recommend a series of customized action items that best meet the specific parameters requested by a user.

Referring back to FIG. 2, aggregate dataset 210 may provide a larger pool of data upon which a predictive ML model (e.g., ML model 100) may be trained. Aggregate data (e.g., aggregate dataset 210) may often lead to more robust ML models, particularly when the data slices (e.g., slices 211) in the aggregate data have similar representations in the feature space, and subsequently the data from one slice may benefit another. Various techniques for measuring similarity/dissimilarity between slices in the feature space include K-Means clustering, K-Nearest Neighbors, Hierarchical clustering, and auto encoder misalignment measures.

A slice's feature space embedding may not be dependent upon the underlying predictive ML model, and many predictive ML models, such as artificial neural networks, explicitly embed the feature vectors into a latent variable space referred to as the latent space. Implementations described herein focus upon the case of artificial neural networks, which generally perform a non-linear, non-isometric transformation from the feature space to the latent space. This has the consequence that similarity/dissimilarity in feature space does not always imply similarity/dissimilarity in latent space.

Example implementations disclosed herein may deviate from feature-space-based measures in that the example implementations focus on latent space misalignment. There may be an underlying motivation for the focus on latent space misalignment. As noted earlier, the latent variables are directly used to determine the model output 140 of ML model 100. While the input feature variables contribute to the model output, it is the latent space (e.g., latent space 130), into which the features are projected, that determines the output when combined with the ML model.

In other words, the knowledge of the feature vectors alone is insufficient to gain knowledge of the final output (e.g., model output 140). The knowledge of the ML model's latent space 130 embedding is to be understood to ensure that one is building models associated with responsible AI concepts. Therefore, obtaining a measure of a slice's misalignment in latent space may provide direct information on the suitability (or lack thereof) between the slice data and the aggregate model, which may be essential for responsible AI and results in decisions in humble AI around abandonment of the model for another decision process or model that is more appropriate.

Furthermore, model explainability may be sensitive to changes in the latent space. Misalignment may result in non-ethical use of a model on a segment of customers or erroneous decision explanations. An analysis that focuses only on the feature space may at best hope for a correlation sense of model explainability, and may miss subtle perturbations in feature space that result in larger shifts in latent space. Note the later occurrence is of particular concern in the area of adversarial examples. This measure may be performed during model development, but importantly it may also be continually evaluated in production to validate the on-going integrity of the model and data in the pursuit of Responsible AI.

As an example implementation, a binary classifier such as a feed-forward artificial neural network (ANN) may be utilized. An ANN may define a function from feature space to the real numbers that is represented by a weighted directed acyclic graph where each vertex (hereafter referred to as a “node”) is associated with a real value, known as a “bias”, and an “activation” function. A key aspect of ANNs is their structure as a composition of layers. A layer is composed of individual nodes where weighted edges (hereafter referred to as “weights”) connect nodes in different layers. The input feature vector forms the input layer, and the output layer consists of a single node that corresponds to the estimated probability of belonging to a particular class. Other intermediate layers may be referred to as hidden layers, whose node values form the latent space.

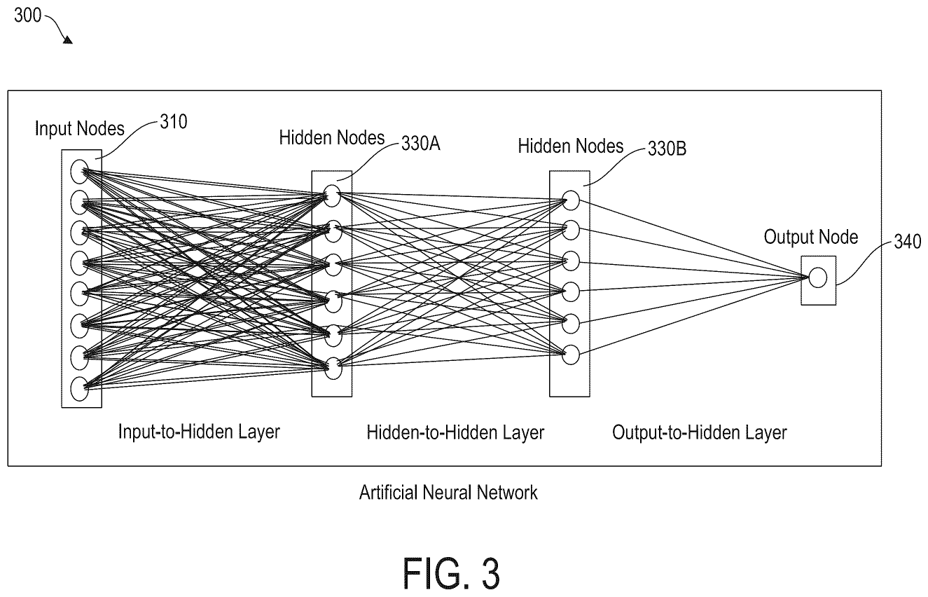

Referring to FIG. 3, a diagram of an example ANN 300 is provided. As shown, the artificial neural network 300 includes an input node layer 310, a hidden node layer 330A, a hidden node layer 330B, and an output node layer 340. As further shown, the input node layer 310 may be transformed to a first hidden node layer 330A; the first hidden node layer 330A may be transformed to a second hidden node layer 330B; and the second hidden node layer 330B may be transformed to generate the output node layer 340.

An affine transformation consisting of a weighted linear combination of the node outputs in the prior layer plus a bias vector is input into the activation function of the nodes in the next layer. More formally, an L-layer ANN may be a function, ƒ(x; W₁, W₂, . . . , W_{L}, b₁, b₂, . . . , b_{L}), parameterized by the corresponding weights, Wᵢ, biases, bᵢ, and piecewise-differentiable activation functions, σᵢ, for each layer i. Note that the choice of activation functions is a hyper-parameter as opposed to a parameter. The output of the ANN 300 may be defined by the following relations:

$$\begin{matrix}f ( x ; {W}_{1} {W}_{2} , … , {W}_{L} , {b}_{1} , {b}_{2} , … , {b}_{L} ) = {σ}_{L} , \\ {σ}_{i} := ( {W}_{i} {σ}_{i - 1} + {b}_{i} ) for i ∈ [ 1 , 2 , … , L ] , \\ {σ}_{0} := x .\end{matrix}$$

Without loss of generality, the term “weight” or “weights” may include both the weights and the bias values (e.g., in a matrix). The ANN 300 may be represented by ƒ(x; W). Given a set of data, (X, y), where X contains the input features and y is the target vector, and a loss function, J(W; X, y), the weights, W, are learned by finding a value that approximately minimizes the loss function:

$${W}^{*} ≅ arg min J ( W ; X ; y ) .$$

In one example embodiment, the weights are learned by minimizing the loss function via back propagation. The weights for the aggregate ANN may be defined as:

$${W}_{aggregate} ≅ arg min J ( W ; {X}_{aggregate} , {y}_{aggregate} ) ,$$

where the corresponding aggregate ANN is ƒ(x; W_{aggregate}).

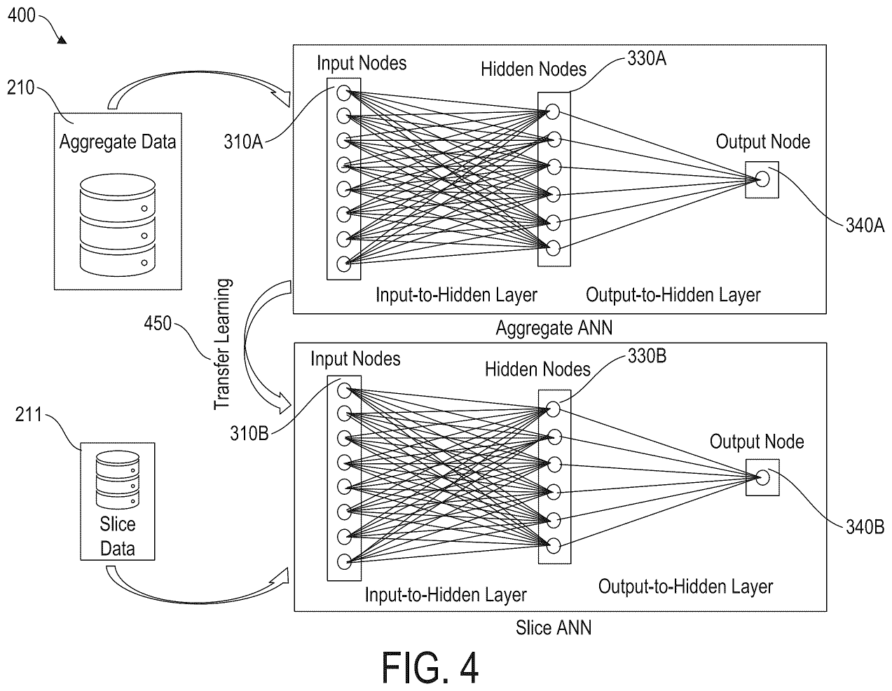

Referring to FIG. 4, a diagram 400 of transfer learning between an ANN and a slice ANN, in accordance with one or more implementations, is provided. In some implementations, an ANN may include a single hidden layer. The associated latent space may be composed of the values of the nodes from the hidden layer, and the mapping from the input feature vector to the hidden layer values is a transformation from the feature space to the latent space. Embodiments described herein provide a measure of misalignment between a data slice and the aggregate model latent space.

As shown in the top portion of the example of FIG. 4, the aggregate ANN includes an input node layer 310, a hidden node layer 330 and an output node layer 340. The bottom portion of the example of FIG. 4 depicts the slice ANN similarly including an input node layer 310, a single hidden node layer 330, and an output node layer 340. As further shown, the slice ANN includes a slice dataset 211 and the aggregate ANN includes the aggregate dataset 210.

A step in determining misalignment between a data slice and the aggregate model latent space utilizes the technique of transfer learning 450, which is applied using the aggregate model weights and the data slice. Transfer learning in ML refers to storing knowledge gained while solving one problem and applying it to a different but related problem. The transfer learning example described herein (e.g., transfer learning 450) proceeds by first initializing the weights of the slice ANN with the weights from the aggregate ANN, then optimizing: W_{slice}≅argmin J(W; X_{slice}, y_{slice}).

The resulting slice ANN is given by ƒ(x; W_{slice}). This provides a meaningful connection between the aggregate latent space and the slice latent space, whereas simply initializing the slice ANN with random weights would have no such connection. After applying transfer learning, the ML model may generate two sets of hidden nodes, one from the aggregate ANN and the other from the slice ANN (e.g., hidden node layer 330A and hidden node layer 330B of FIG. 4).

The aggregate latent space and the slice latent space may now be compared by applying a measure of distance on the distribution of hidden node activation values based on the data slice. Many statistical distance measures may be used here such as the Wasserstein distance or the Kolmogorov-Smirnov distance. Without loss of generality, the examples described herein use the Wasserstein distance, which provides a measure of distance between probability distributions. Besides having many pleasing theoretical properties, the Wasserstein distance offers an intuitive explanation of distance. By viewing the probability distributions as mounds of dirt, the Wasserstein distance may be understood as the minimum amount of work required to transform one probability distribution into the other, thus it is also referred to as the Earth Mover's distance.

A consequence is that the Wasserstein distance does not saturate in value, unlike the Kolmogorov-Smirnov distance, thereby providing greater resolution in case of larger distances. Additionally, the distance does not restrict itself by leveraging only a particular moment or extremal statistic of the distributions, but instead it is able to integrate many different properties such as mode and kurtosis for a more complete notion of distance. Applying the Wasserstein distance to each hidden node provides a measure of misalignment between the corresponding aggregate and slice hidden node(s). Since there may be many hidden nodes in a single hidden layer, this provides a vector of values,

$$\vec{{m}_{l}} = m ( {P}_{i} , {Q}_{i} ) ,$$

where i represents the i^{th} hidden node, m is the Wasserstein distance, Pᵢ is the distribution of the i^{th} hidden node activation values from the consortium ANN ƒ(x; W_{consortium}), and Qᵢ is the distribution of the i^{th} hidden node activation values from the slice ANN ƒ(x; W_{client}).

At least one Wasserstein hidden node distance may be multiplied by the absolute value of its corresponding hidden-to-output weight value in the aggregate ANN, Wᵢ:

$$\vec{{m}_{l}} \cdot \vert {w}_{i} \vert$$

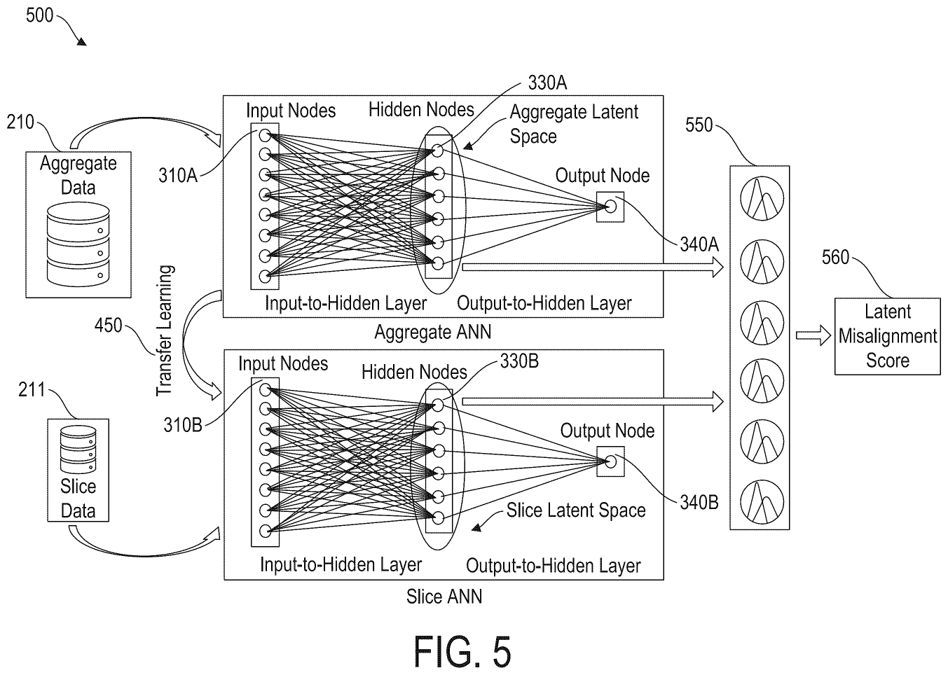

As a result, a hidden node is weighed by a notion of importance with respect to the aggregate ANN. Some hidden nodes will invariably contain low information value and a subsequent large changes in distribution will not be as informative in terms of misalignment. A ML model with reasonable regularization would assign small weights to such low information nodes, thereby reducing their influence on the final measure. Finally, to have a single value of latent space misalignment, the [symbol] _{∞}—norm is applied:

$$LMS = {‖ \vec{m} * w ‖}_{∞} ,$$

where LMS denotes the Latent Misalignment Score (see FIG. 5) and * denotes element-wise vector multiplication.

Referring to FIG. 5, a diagram 500 of the aggregate ANN and the slice ANN calculating and generating a latent misalignment score is provided. As shown, in this example embodiment, the latent space of the aggregate ANN (e.g., hidden node layer 330A) and the latent space of the slice ANN (e.g., hidden node layer 330B) may be combined and/or compared at hidden node latent space 550. As further shown, a latent misalignment score (LMS) 560 may be calculated and generated as described above.

In some aspects, the range of values of a LMS may vary greatly depending upon the underlying aggregate model and the degree of homogeneity or heterogeneity among the slices of data composing the aggregate data. The following are three possible instantiations of aggregate and slice data:
A slice is a separate client financial institution, and the aggregate is a consortium of client data.
A slice is a sub-portfolio of data within a single client financial institution, and the aggregate is the client's entire portfolio of data.
The aggregate is a single dataset and a slice is given by a random or semi-random split of the data.

In the first and second instances, the level of diversity among the clients or among the sub-portfolios of a single client may lead to greater inhomogeneity in the aggregate data. Conversely, in the last case, a random splitting on a sufficiently sized dataset would be expected to confer a larger degree of homogeneity among the slices in the aggregate data. Given the level of homogeneity would be quite different in the cases outlined above, it may be desirable to have a measure of misalignment for each slice that is relative to the measure of misalignment among the other slices. Then the following steps may be taken to provide a relative measure of aggregate misalignment. Denoting the sample mean across slice LMS values by x̅ and the sample standard deviation by s, the following standardized LMS value may be calculated for the j^{th} slice:

$$\overline{{LMS}_{J}} = \frac{max ( {LMS}_{j} - \overline{x} , 0 )}{s} .$$

An aggregate misalignment score for a given slice may provide one measure of aggregate model suitability for that slice, and this misalignment score has implications for responsible AI and the appropriateness of the aggregate ML model (or underlying decision process) for the given slice. A high LMS (e.g., satisfying a threshold) may indicate that a different model or even decision process may need to be considered to deliver more optimal performance or more importantly to ensure responsible use of AI, and moreover with the misaligned data slice removed the other data slices may benefit from the revised aggregate data and resulting machine learning model development.

As a demonstration of the misalignment scoring described herein, we consider the first of the 3 cases outlined above. In an illustrative example, a consortium model is used for credit card fraud detection and developed from a collection of financial institutions in the United Kingdom and Ireland (UK/I). For each client in the consortium data, a client ANN is developed by initializing the ANN with the consortium ANN weights, then optimizing the weights via the client's data and back-propagation. With a client ANN in hand, the values of the hidden nodes for both the client ANN and the consortium ANN are calculated by forward propagating the non-fraud feature vectors through each respective ANN.

Note the fraud feature vectors are excluded in this evaluation, as the stable and persistent population of interest is the client's collection of non-fraud payment card transactions. However, there could be some scenarios in which the fraud data may be used as well. The set of values for each hidden node generates a 1-dimensional empirical distribution for each hidden node from the respective ANN. Multi-nodal and multi-dimensional empirical distributions may be considered, as well as other combinations of the node empirical distributions, but the use of transfer learning generally enables straight-forward 1-dimensional node distribution analysis to be sufficiently informative.

Transfer learning may increase the likelihood that the stochastic dynamics of the learned weights remain near a particular basin of attraction, although both the severity of misalignment (e.g., a LMS value) and the size of the slice (e.g., slice 211) may contribute to the resulting shift in weight space and latent space. This may yield two empirical distributions for each hidden node, one for the client/slice model and one for the consortium/aggregate model. Applying the Wasserstein distance to each pair of empirical distributions, yields a Wasserstein distance for each hidden node, which is then multiplied by the corresponding hidden-to-output weight of the consortium ANN. The resulting vector is reduced to a single value by application of the l_{∞}—norm. This results in a single LMS value for each slice in the aggregate model. To obtain a standardized sense of aggregate misalignment, the sample mean and standard deviation across slice LMS values is calculated, and the number of standard deviations above the mean is produced for each slice.

The Wasserstein distance between the distributions of the i^{th} hidden node of the consortium ANN Pᵢ and the j^{th} client ANN

$${Q}_{i}^{j}$$

is:

$$\vec{{m}_{l , J}} = m ( {P}_{i} , {Q}_{i}^{j} ) ,$$

where m denotes the Wasserstein distance. Applying element-wise multiplication to the absolute values of the hidden-to-output weights with a matrix of node Wasserstein distance values, then applying the [symbol] _{∞}—norm to each column yields a single LMS value for each client.

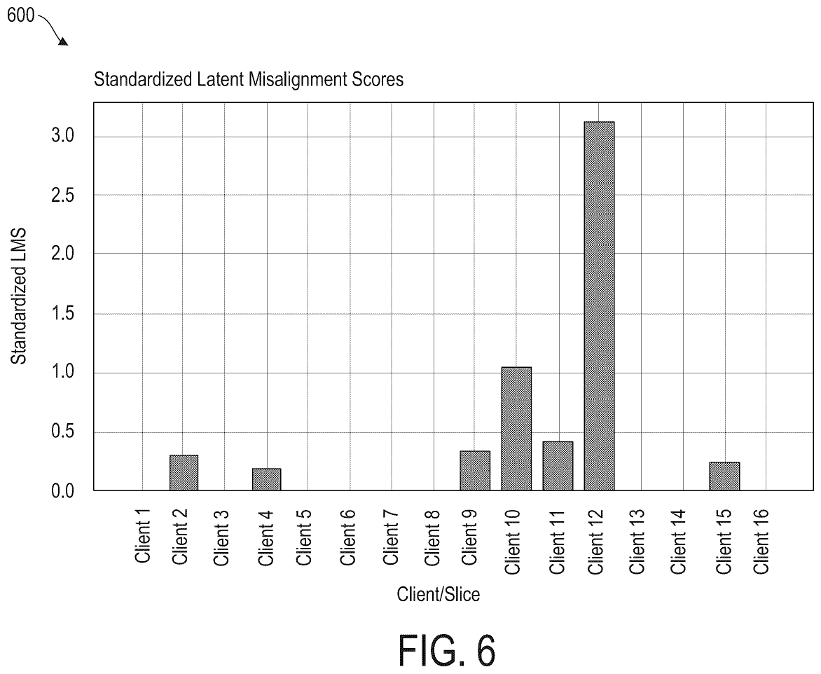

Referring to FIG. 6, a graph diagram 600 is provided illustrating misalignment scores for different slices of data, in accordance with one or more implementations. As shown, the values indicate that one client (e.g., client 12) has the highest measure of latent-space misalignment with the consortium ANN. To get a better sense of just how misaligned this one client is with respect to the other clients in the consortium, the LMS values are standardized by, for example, calculating the sample mean and standard deviation of LMS values across all clients in the consortium, then transforming the LMS value as follows:

$$\overline{{LMS}_{J}} = \frac{max ( {LMS}_{j} - \overline{x} , 0 )}{s} .$$

Other non-parametric or robust measures of typicality and spread may be used, but for many applications the empirical first moment and centered second moment will suffice to control for the variety of observed LMS scores. As shown in FIG. 6, client 12 is the most misaligned client with respect to the consortium ANN, while another client (client 10) shows some misalignment as well, although it is considerably less than client 12. Thresholding at more than one standard deviation above the mean, indicates that client 10 and client 12 both warrant further examination or action in order to adhere with responsible AI.

Examining the data for client 12 in the example of FIG. 6 may reveal a sub-portfolio of payment cards that differ from the more common payment card sub-types that compose the majority of the data used in the UK/I consortium model. While client 10 may have many sub-portfolios of payment card sub-types that are common in the consortium data, it also has a couple of different payment card subtypes that aren't as well aligned. As a result, the LMS values for these clients have picked up on deviations in the latent space that may be used to guide these slices towards more appropriate models consistent with Responsible AI.

A misalignment in the aggregate latent space may imply sub-optimal decisions and/or erroneous decision explanations that may be remedied with better model alignment (e.g., applying a different ML model to a dataset or data slice). The upshot is potentially better explainability and additional guidance towards humble AI. Furthermore, LMS values should be regularly monitored once the decision process is in production to ensure the continued viability of the decision management system in accordance with Responsible AI.

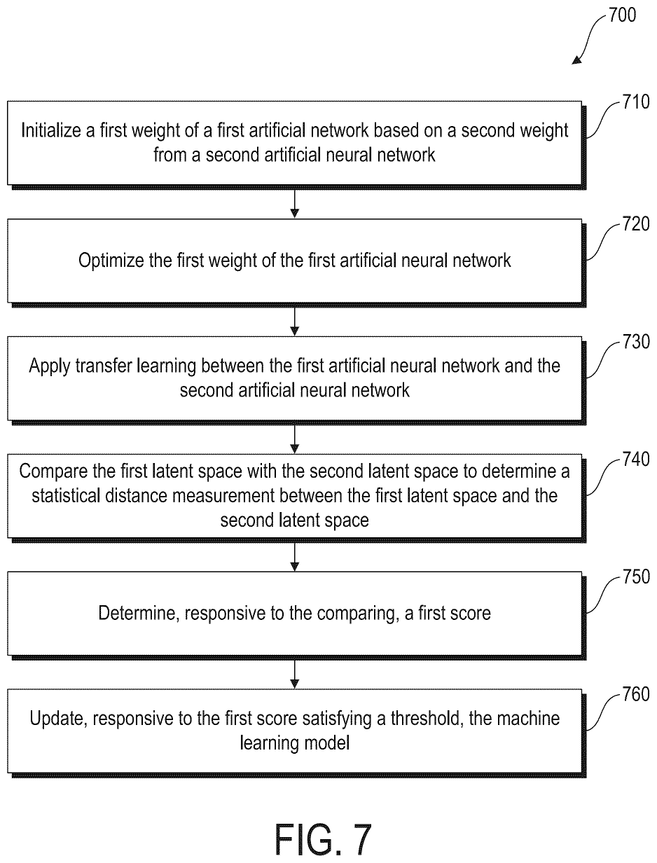

Referring to FIG. 7, a flow diagram of an example process 700 for identifying misalignment in a latent space of a ML model is provided. The process 700 may be implemented as part of a computing system such as a decision software. Referring to FIGS. 1-7, the process 700 may be implemented as part of a computing system such as a decision software. As shown, a measure (e.g., latent misalignment score 560) to programmatically identify misaligned slices of data (e.g., slices 211) in the aggregate latent space of ML models has been described. The LMS measure has been validated to quantitatively determine how well-aligned/misaligned a given sub-population of data is with respect to a ML model.

At operational block 710, for example, a first weight matrix of a first artificial neural network may be initialized based on a second weight matrix from a second artificial neural network. For example, one or more weights of a slice ANN (e.g., a first weight) may be initialized with one or more weights from the aggregate ANN (e.g., a second weight).

At operational block 720, the first weight matrix of the first artificial neural network is optimized. For example, the weight matrix may be optimized via the aggregate and/or slice data and back-propagation. In some aspects, operational blocks 710 and 720 may be optional. For example, an existing artificial neural network model may be running at a client side apparatus and may not need the initialized weights that are later optimized. Rather, the weights of the existing artificial neural network model may be transferred to the second artificial neural network, as described in block 730.

At operational block 730, transfer learning is applied between the first artificial neural network and the second artificial neural network. The first artificial neural network may include first hidden nodes defining a first latent space. The second artificial neural network may include transfer learned second hidden nodes defining a second latent space and a second transfer learned weight matrix. For example, transfer learning may yield two empirical distributions for each hidden node, one for the client/slice model and one for the consortium/aggregate model.

At operational block 740, the first latent space may be compared with the second latent space to determine a statistical distance measurement between the first latent space and the second latent space. For example, the aggregate latent space and the slice latent space may be compared by applying a measure of distance (e.g., a Wasserstein distance) on the distribution of hidden node activation values based on the data slice.

At operational block 750, responsive to the comparing, a first score is determined. For example, the first score may include a latent misalignment score determined by at least multiplying the measurement of distance (e.g., the Wasserstein distance) by an absolute value of its corresponding hidden-to-output weight value in the aggregate ANN.

At operational block 760, responsive to the first score satisfying a threshold, the machine learning model is updated. For example, if the first score (e.g., LMS score) satisfies a threshold, it may be determined that misalignment is too high and that a different ML model or decision process may need to be considered (e.g., applied) to deliver more optimal performance or more importantly to ensure responsible use of AI, and moreover with the misaligned data slice removed the other data slices may benefit from the revised aggregate data and resulting ML model development.

In some embodiments, an ML model may be deployed to analyze data or features associated with an individual, entity, or applicant's profile, where the applicant is attempting to apply for a loan or credit. Based on the analysis of such features, the ML model may approve or deny an applicant or application, or may determine and assign a risk score to the applicant or application. In some example implementations, the ML model may be deployed to analyze an existing assessment rating (e.g., a current credit score) and other metrics such as an expected rating (e.g., a target credit score) in expected timeframes (e.g., a target time for achieving the target credit score).

Based on the provided information, the ML model may simulate a plurality of plans or scenarios and provide recommendations on how the existing assessment rating may be improved. In the following the term plan or scenario is used interchangeably and refers to a collection of planning statements and/or action items. A plurality of scenarios or plans may be simulated by the ML model in response to receiving a target score and an associated time horizon. These criteria, along with credit report data elements, may be part of aggregate datasets that are processed and analyzed by the ML model to provide a set of actions that may be taken to achieve the target score in a least burdensome manner.

In one or more embodiments, to generate a score, credit data associated with an individual or entity is pre-sorted into one of a number of segments or scorecards within the overall modeling algorithm or credit scoring system. Each scorecard in the system may have a unique set of characteristics or attributes to be calculated from an individual's credit report data. Based on an algorithm and weighting scheme, a credit scoring system, including the ML model, may generate a score within a range of scores.

Depending on where an individual's calculated score lands within the range of scores, the individual's creditworthiness is assessed. For instance, a score at a higher range indicates that the individual may be a very low credit risk and is likely to be extended credit by a bank or financial institution. Conversely, a score at a lower range indicates that the individual may be a very high credit risk, and is likely to be denied credit by the bank or financial institution. Scores have application in other areas as well, such as being a factor to determine the interest rate to charge for the loan or in determining a credit line adjustment.

In some embodiments, a generated score is based on a comprehensive set of categories of information from a credit report. For example, a score may be driven by a number of categories including, without limitation, payment history, amount of debt, length of credit history, type of new credit requested, and credit mix. A scoring algorithm may calculate characteristics from each of these categories, assign component score weights based on the characteristic values, and then produce an aggregate score.

When generating a score, several factors (e.g., top five score factors) may be provided for display indicating the main reasons why the score was not higher or as expected. For example, a credit report may include a score, as well as a list of factors that have weighed adversely on that score, such as the number of late payments, the ratio of balance to available credit, or a duration over which certain credit accounts have been held by the individual. Such factors may be helpful to the individual for understanding what might be affecting the individual's score.

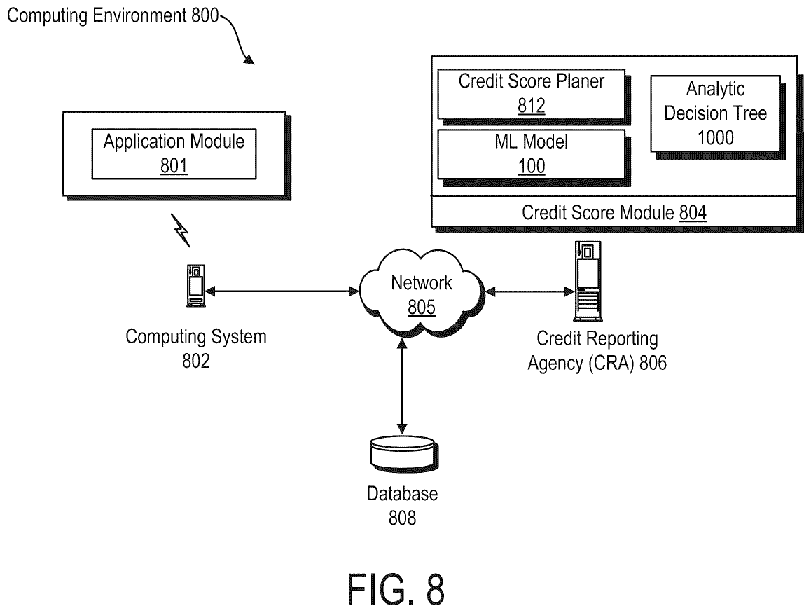

Referring to FIG. 8, a credit score planner (CSP) 812 may be implemented over a secure computing environment 800 that allows an individual, entity, computing system, or user to input a target score and an associated target time duration. These input values, along with credit report data elements, are processed and analyzed by ML model 100 and analytic decision tree 1000 to generate a set of action items the user may follow to reach the target score. The CSP 812, as provided in further detail below, is configured to allow a user to quickly understand if a target score is feasible and if not suggest one or more action items to help the user best achieve the target.

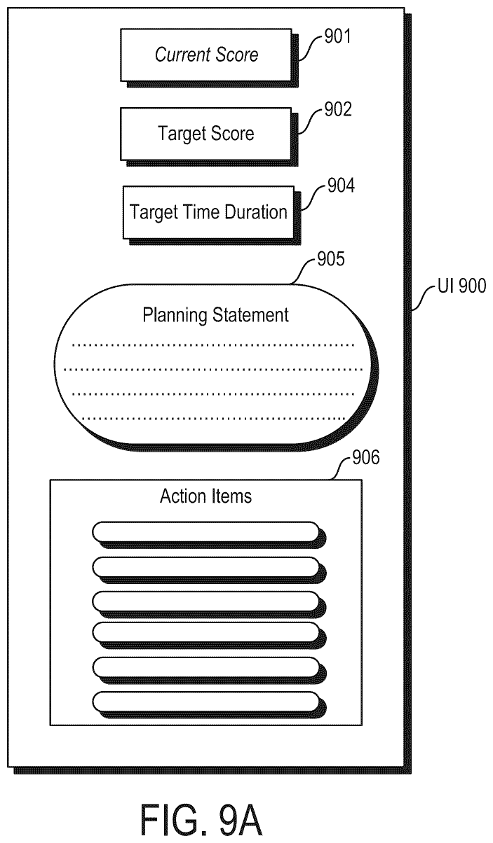

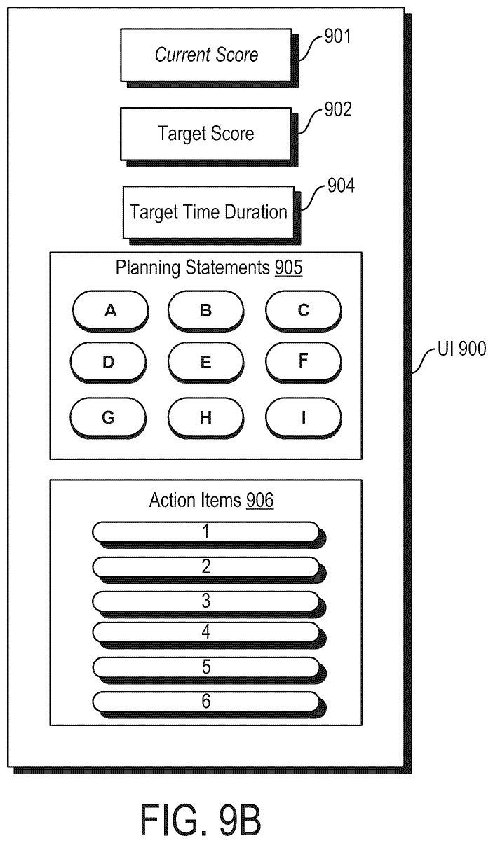

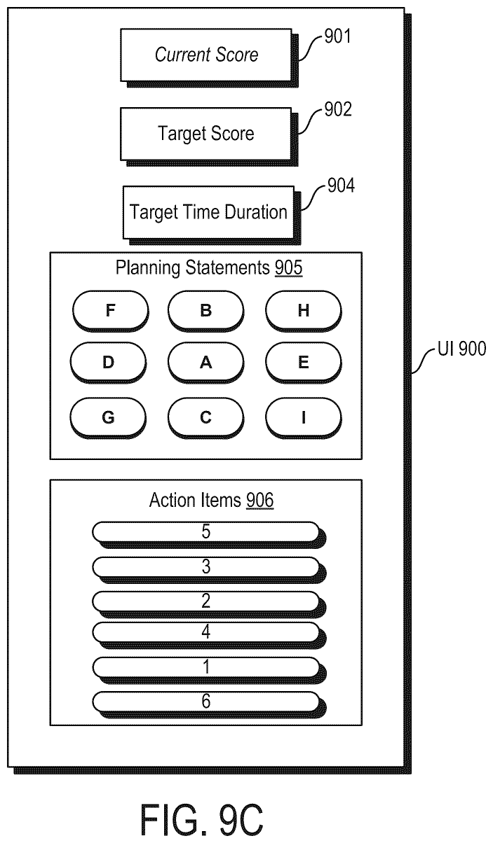

Referring to FIGS. 8, 9A and 9B, computing environment 800 and user interface (UI) 900 are provided to facilitate user interaction with CSP 812. CSP 812 may communicate with a knowledge base (e.g., database 808) that includes information about the user's credit history and other credit information. The computing environment 800 may include a computing system 802, which hosts application module 801 for processing user data input or applications received from an individual or entity or user. CSP 812, ML model 100, and decision tree 1000 may be hosted in one or more local or distributed environments.

Computing system 802 may be used, for example, directly by a user (e.g., an individual, an entity, or a financial institution) to input data and process applications for credit, loan, or other financial instruments submitted by a user or consumer. Computing system 802 may communicate with a credit reporting agency (CRA) 806 via a network 805. The CRA 806 may host or execute a credit score module 804 that communicates with CSP 812 to generate scores associated with one or more users. As shown in FIG. 8, CSP 812, ML model 100, and decision tree 1000 may be executed or hosted over CRA 806 or other computing systems coupled to network 805.

In one or more implementations, computing system 802 or CRA 806 may host or communicate with CSP 812. CSP 812 may receive input, such as a target score and an associated target time duration, from application module 801, for example. The target time duration may be defined by a target date in the future by which the user desires to achieve the target score. Depending on implementation, CSP 812 may be implemented in software, firmware, or hardware to process the input data in view of the user's credit report data elements available via CRA 806.

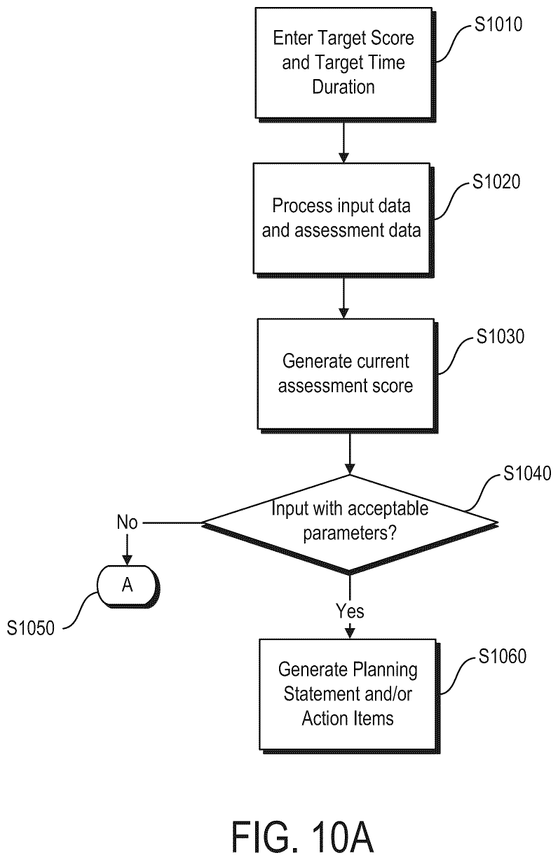

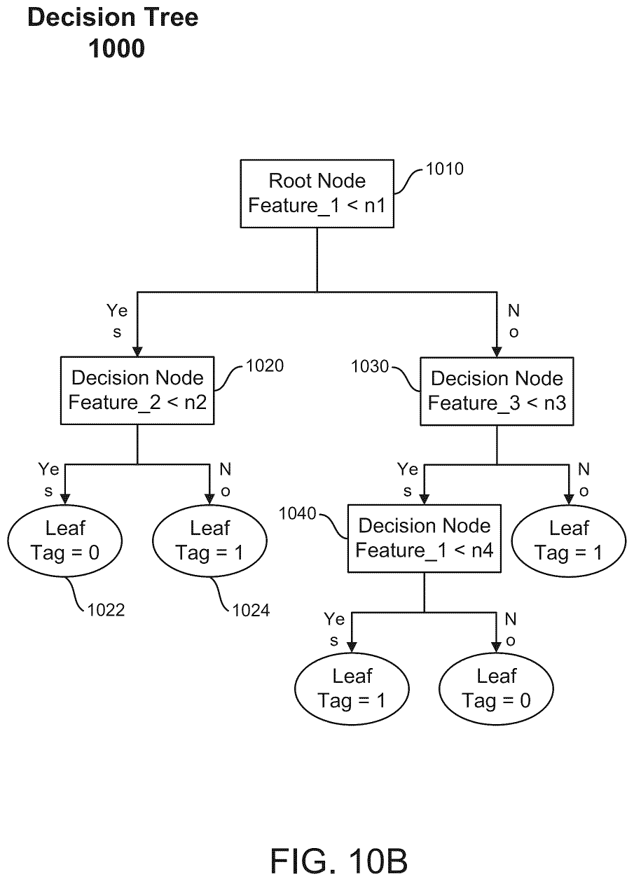

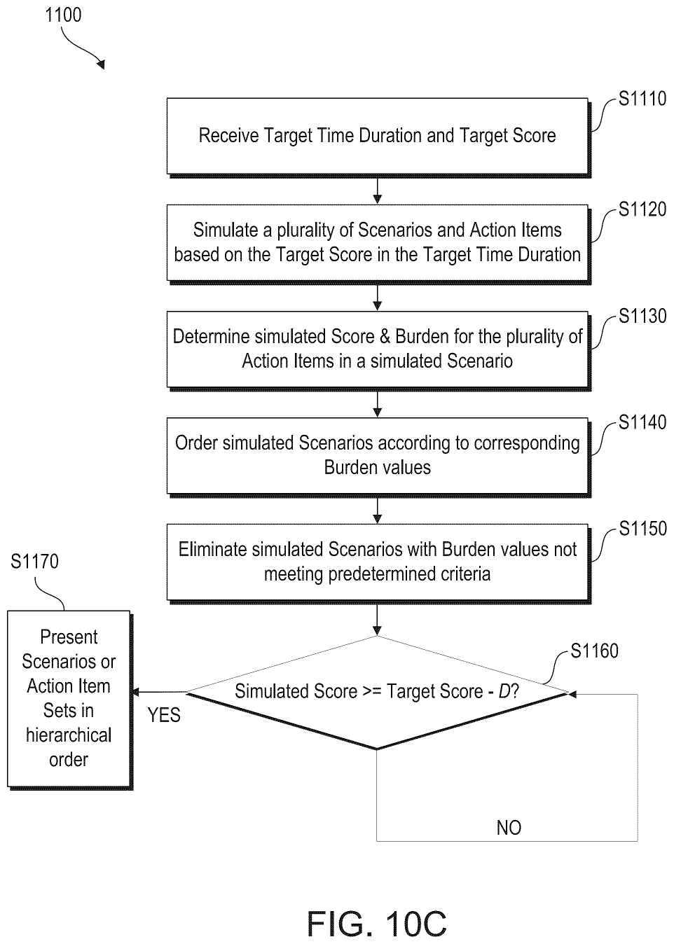

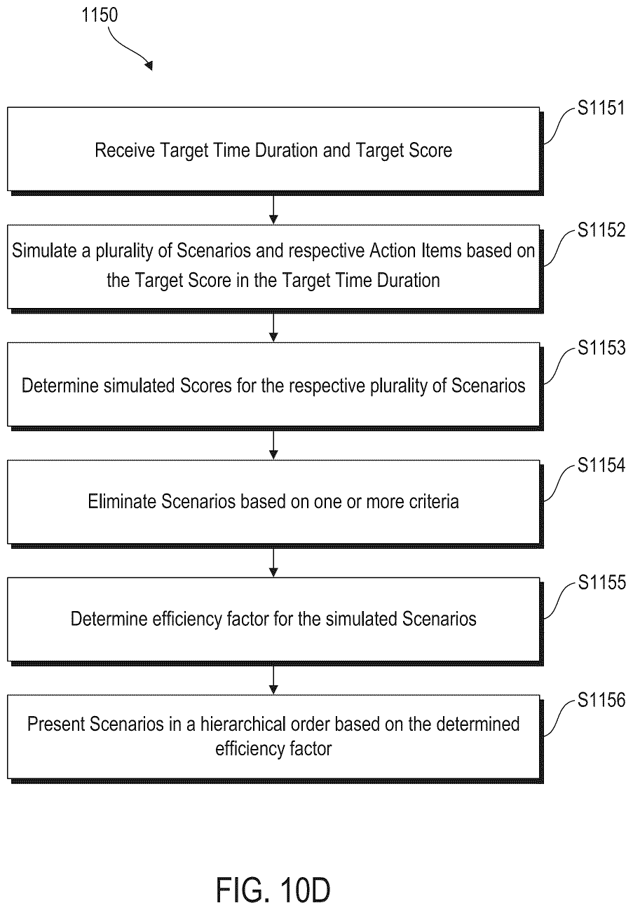

The collected user data may be analyzed by CSP 812 to determine a set of actions the user may take to potentially reach a target score in the target time duration. For example, CSP 812 may use an ML model (e.g., ML Model 100) to simulate a plurality of scenarios that include one or more planning statements or action items to help achieve the target score. CSP 812 may also use an analytic decision tree (e.g., decision tree 1000 in FIG. 10B) to select from the simulated scenarios the most practical, efficient, or least burdensome scenarios and a corresponding set of planning statements or action items.

Accordingly, CSP 812 (in conjunction with the other functional and structural elements of computing environment 800) may generate results that allow the user to quickly understand if achieving the target score within the target time duration is practical or feasible. If so, CSP 812 generates via a user interface a set of actions that the user may take to potentially reach the target score. Depending on implementation, the user interface may be incorporated as a part of application module 801 executed over a computing system 802 (e.g., user device). CSP 812 may, either directly or indirectly, communicate with computing system 802, as shown in FIG. 8.

Referring to FIGS. 9A and 10A, an individual or entity or user may interact with UI 900 to input a variety of information, including a target score 902 and a target time duration 904 within which the target score 902 is to be achieved (S1010). The CSP 812 may analyze or process the input data in conjunction with assessment data available about the individual or entity (S1020). In some implementations, CSP 812 may analyze or process the input data using ML model 100. Based on the analysis, CSP 812 may generate a current (i.e., up-to-date) assessment score 901 (S1030), for example, using a credit scoring algorithm. Alternatively, the current assessment score may be retrieved from another source.

In some implementations, the input data is analyzed to determine if the input data is within acceptable parameters (S1040). For example, the target score 902 entered may need to be within an acceptable range, or otherwise may not be accepted (S1050). In one example embodiment, the target score 902 may need to be at least a certain number of points (e.g., 20 points) greater than the current score 901. For example, if the current score is 700, the target score selected may need to be at least 720. Furthermore, the target score 902 may not be greater than a maximum allowable score (e.g., 850).

If the input provided through UI 900 is within acceptable parameters, a plurality of scenarios, including one or more planning statements 905 and/or a set of action items 906 may be generated or simulated (S1060). Taking the steps in the suggested action items may allow the individual or entity to achieve the target score 902 within the target time duration 904. If the target score 902 is not achievable within the target time duration 904, an alternative time duration or set of action items may be suggested by CSP 812. In one example, UI 900 may provide a selection menu of 3, 6, 9 or 12 months for the target time duration 904, for example.

Referring to FIG. 9B, in certain implementations, UI 900 may be a graphical user interface (GUI) configured such that a plurality of planning statements 905 and a plurality of corresponding action items 906 are displayable in different areas of the GUI. As shown in the middle portion of UI 900, a set of planning statements A through I may be displayed in a first area of the GUI and a set of action items 1 through 6 may be displayed in a second area of the GUI, responsive to values in fields 901, 902, and 904.

Referring to FIG. 9B, in the upper portion of UI 900, a current score may be displayed in field 901, a target score may be displayed in field 902, and a target time duration may be displayed in field 904. In one embodiment, one or more of these values may be entered directly by way of user interaction (e.g., FIG. 10A at S1010) or may be retrieved from a data source (e.g., FIG. 8, database 808), or may be generated in real time.

Referring to FIG. 9B, in the lower portion of UI 900, based on at least the target score 902 and the target time duration 904, ML model 100 may be utilized to simulate a plurality of scenarios including one or more planning statements 905 and corresponding action items 906 (e.g., using the weight matrix). As provided in further detail herein, based on the simulation and with reference to rules or priorities defined by a decision tree, a first scenario associated with a first planning statement A and a first set of corresponding action items 1 through 6 may be determined.

Referring again to FIG. 9B, as shown in the middle portion of UI 900, additional scenarios associated with additional planning statements (e.g., planning statements B through I) and their respective set of corresponding action items may be also simulated by ML Model 100. The first scenario may achieve one or more favorable outcomes (e.g., achieve a first possible score within a first possible timeline). A second scenario may achieve one or more other favorable outcomes (e.g., achieve a second possible score within a second possible timeline). Yet, a third scenario may also achieve certain favorable outcomes (e.g., achieve a third possible score within a third possible timeline), and so on.

Depending on implementation, the generated scenarios are ranked based on at least one or more of the following factors (e.g., using a decision tree or other analytic data structure):
How closely the possible score determined for a scenario matches the target score 902
How closely the possible timeline determined for a scenario matches the target time duration 904
How burdensome, practical, or efficient it is, for a particular entity, to achieve the respective action items for a planning statement associated with a scenario

A first scenario may be ranked in a more elevated hierarchical position compared to a second scenario if: (1) the action items suggested for the first scenario are less burdensome (e.g., easier or more practical to achieve) than the action items suggested for the second scenario, or (2) if performing the action items suggested for the first scenario within the first timeline results in a score that matches or exceeds the target score, while performing the action items suggested for the second scenario results in a score that does not exceed the target score.

Accordingly, based on the set of factors and results associated with the various scenarios, the scenarios are ranked in a predetermined order (e.g., from most favorable to least favorable). In response to the ranking, at least a first planning statement and a first set of corresponding action items are generated for display (i.e., based on the elevated hierarchical position of the first scenario over other possible scenarios). As shown in FIGS. 9B and 9C, multiple planning statements A through I may be generated according to their hierarchical ranking based on, without limitation, the set of factors noted above.

Depending on implementation, if one or more of the values associated with current score 901, target score 902, or target time duration 904 are changed or updated, CSP 812 may redetermine the possible scenarios and update the order of planning statements 905 so that a better suited planning statement is positioned ahead of or in advance of other planning statements. In other words, as shown in FIGS. 9B and 9C, the hierarchical ranking of the planning statements A through I may change based on a change in values 901, 902, or 904. As a result, the display position of said planning statements A through I may be reordered on the display to allow a user more easily view and determine the most suitable planning statements 905 and the corresponding action items 906 associated with the more favorable scenario.

In the example embodiment shown in FIG. 9B, in response to an entity interacting with UI 900 to select one of the planning statements 905, a corresponding set of action items 906 (e.g., action items 1 through 6) may be displayed. Similar to the hierarchical ranking and reordering disclosed above with reference to planning statements 905, action items 906 may be also ranked hierarchically and displayed in a certain order. For example, action item 1 may be ranked higher than action item 2, if performing action item 1 would result in achieving the target score 902 within target time duration 904 in a more practical manner or in a less burdensome manner.

In accordance with one or more embodiments, CSP 812 may not be able to provide suggestions to improve current score 901. In some embodiments, if the current score does not match a predetermined criteria (e.g., is below or above a threshold value), then the user may not be allowed to enter a target score 902 or target time duration 904. Thus, if input data (such as target score 902 or target time duration 904) or the current score 901 falls outside a predetermined range (e.g., below a minimum or above a maximum threshold), then no scenarios, planning statements, or action items may be simulated.

Referring to FIG. 10B, CSP 812 may utilize an analytic decision tree 1000 to finetune, arrange, rearrange, or limit the number of scenarios simulated by ML model 100. Decision tree 1000 may be either external or integrated into ML model 100 to help sort or arrange the simulated scenarios in a particular order based on certain predefined scoring factors or characteristics. In one example embodiment, analytic decision tree 1000 may be paired with ML model 100 to hierarchically rank a plurality of possible scenarios, generating several recommendations that are most favorable (e.g., most realistic, practical, reasonably achievable, or least burdensome).

Depending on implementation, decision tree 1000 may have a depth of three levels for a binary tag. Decision tree 1000 may be a flowchart-like data structure with a root node 1010 and multiple decision nodes 1020, 1030, and 1040. A decision node represents a probability test on an attribute (e.g., whether a coin flip comes up heads or tails), and a yes or no branch represents the outcome of the test. A leaf node (e.g., leaf 1022) represents a class label or value (e.g., 0 or 1) which refers to a decision taken after computing one or more attributes. Decision tree 1000 may be utilized for classification or regression analysis. As shown, root node 1010 is the initial node at the beginning of a decision tree, where the entire population or dataset starts dividing based on various features or conditions. Decision nodes are intermediate decisions or conditions within the tree which result from the splitting of root nodes or other decision nodes. Leaf nodes indicate the final classification or outcome. At a decision node, a certain feature (e.g., the most important feature) is examined to split the data into the most distinct groups of tags by using impurity measures such as Gini impurity, for example, given by:

$$Gini Impurity ( G ) = 1 - {\sum }_{i = 0 , 1} {p}_{i}^{2}$$

where pᵢ is the probability of samples belonging to class i at a given node.

In this example, when the data is split into two branches B1 and B2 at a decision node, the Gini impurity in resultant split is calculated by

$$\frac{{n}_{1} {G}_{1} + {n}_{2} {G}_{2}}{{n}_{1} + {n}_{2}} ,$$

where G₁, G₂ are Gini impurities of B1 and B2 and n₁, n₂ are the number of data points in branches B1 and B2. At a decision node, the attribute split that provides the smallest Gini impurity, for example, is chosen to split the node.

In some implementations, the user may enter or select multiple different target-score and target-time duration combinations (e.g., ((TS1, TD1)) and ((TS2, TD2))). CSP 812 may dynamically generate or simulate, for a (TS, TD) combination, a plurality of scenarios, including one or more recommendations or action items most favorable for the particular (TS, TD) combination. For example, the user may select a first target score and target time duration combination (TS1=600, TD1=3 months), or the user may select an alternate target score and target time duration combination (TS2=550, TD2=2 months), and so on. In the first example scenario (TS1, TD1), the CSP 812 may generate the following results:
Reduce your total revolving/open account balances of $6000 by $200 each month for 3 months.
Stay current on your payments so that your most recent delinquency ages to 1 year, 4 months.

Alternatively, if CSP 812 determines that the specifically selected combination (TS1, TD1) is not achievable, the system may suggest an alternative combination that would result in achieving a target score of 590 in a time duration of 6 months, based on the following suggested action items:
Reduce your total revolving/open account balances of $6000 by $100 each month for 6 months.
Stay current on your payments so that your most recent delinquency ages to 1 year, 7 months.

The recommended action items by CSP 812 may be customized based on the specific user's credit history and credit information in such a way as to make the suggested actions the least burdensome among a set of many possible actions for that particular user and in order to best optimally achieve the target score in the target time duration. By hierarchically queuing or ranking the various possible scenarios, the recommendations may be ranked most favorably (e.g., in a least burdensome manner) to achieve the user's goals.

For example, while reducing total revolving or open account balances by $900/month for 6 months would achieve the target score in the target time duration, ML model 100 may simulate and evaluate multiple additional scenarios and, for example, may recommend reducing total revolving/open account balances by $100/month for 6 months, thus recommending the least burdensome amount that achieves the target score by the target time duration. Further, the customized strategy provides a proposed plan and action items that forgo requiring the user to guess or unduly attempt to follow generically supplied suggestions that may indeed adversely affect their score or all together fail to achieve the intended results.

Referring to FIG. 10C, an example process 1100 for simulating a plurality of scenarios (e.g., planning statements 905 and/or actions items 906) is provided, where the most suitable or practical scenarios are selected and presented in a hierarchical arrangement. In some embodiments, process 1100 may generate one or more action items 906 associated with a planning statement 905 based on certain criteria. As provided in further detail herein, the criteria may be related to characteristics associated with risk data available for an individual or entity applying for credit. A planning statement 905 includes one or more action items 906 that, if followed, provide for a specific target score to be achieved by a specific time duration.

Referring to FIGS. 1, 8, 9A, 9B, 10B, 10C, and 10D, a user may interact with UI 900 to provide application module 801 with input data. The input data may include, without limitation, a target score 902 and a target time duration 904 (S1110) desirably with the goal that the target score 902 may be achieved by the target time duration 904. The received input data may be transferred over network 805 to CSP 812. In some implementations, additional data may be accessed by or provided to CSP 812 by way of submitting an inquiry to database 808.

The data included in database 808 may comprise a variety of risk analysis information. The data may include, for example, one or more of: a starting score (e.g., a current score), revolving account balances, credit histories, delinquencies, payment amounts, payment histories, payment dates, criminal records, civil records, bank account transactions and balances, or threshold values associated with burdens or efficiencies related to accomplishing certain milestones or completing one or more recommended action items.

As shown in FIG. 10C, based on the received data through UI 900 and accessible information in database 808, CSP 812 may generate or simulate a plurality of scenarios that include a set of action items with a potential to best achieve target score 902 by target time duration 904 (S1120). In one example implementation, ML model 100 and analytic decision tree 1000 may be utilized by CSP 812 to generate one or more action items by taking into account predefined parameters and respectively assigned weights for simulation of a plurality of scenarios based on certain input values.

As provided in further detail herein, CSP 812 may utilize ML model 100 to simulate a plurality of scenarios that suggest one or more planning statements or action items, for example, that best achieve target score 902 in time duration 904. Further, the CSP may utilize decision tree 1000 to select and generate, filter, or sort in a hierarchical order (e.g., the most relevant, most efficient, or least burdensome) planning statements, action items, or recommendations that best satisfy the target score-target time duration tuple according to definable parameters or threshold values.

The definable parameters or threshold values may be selected as relevant to determining burden values or efficiency values associated with one or more planning statements or action items generated by CSP 812. As provided in further detail herein, total burden values or efficiency values may be determined for a planning statement or a set of action items, at least in part, based on the type or number of action items recommended for achieving a simulated score. The calculated credit score in a simulated scenario may be higher, equal, or lower than target score 902. In other words, different scenarios may generate different simulated scores, each based on different action items that are respectively associated with different burden values.

Referring back to FIG. 10C, the simulated score and the total burden for the plurality of action items suggested in a simulated scenario may be determined (S1130). The total burden, in one example embodiment, may be determined based on a heuristic or algorithm that takes into account one or more factors associated with satisfying the recommended action items. As provided in examples disclosed herein, these factors may include credit data associated with an individual or entity. The recommended action items may include one or more of: making a payment, paying off a balance, deadline for paying off a balance or making a payment, submitting a request for credit, and avoiding or limiting delinquencies for a period of time.

Different burden values may be assigned to different action items suggested in a simulated scenario based on the difficulty level associated with satisfying a recommended action item. In some implementations, action items that are more burdensome may be assigned a higher burden value or score, for example, and action items that are less burdensome may be assigned a lower burden value or score. Other factors may also impact the burden value determination. For example, action items with a longer duration may be assigned a higher burden value because longer plan durations are generally more burdensome. A suggested action item with a duration longer than the selected target time duration may be assigned a significantly higher burden value, in some embodiments.

In accordance with certain aspects, the burden value for a scenario with a lower debt paydown amount per month is lower than a similar scenario with a higher debt paydown amount. In other words, a simulated scenario that suggests a high monthly payment amount may be determined to be more burdensome than another scenario with a lower suggested monthly payment amount. In some instances, action items that include applying for new or higher credit limits, in proportion to currently available credit limits, may be determined as highly burdensome. That is, a significant burden value may be associated with or assigned to applying, qualifying for, or taking on new credit.

Referring back to FIG. 10C, once multiple scenarios with their respective action items are simulated and the corresponding simulated score and total burden for the scenarios is determined (S1120-S1130), an ordered list of scenarios and the respective action items may be generated according to, at least in part, the corresponding burden values for the simulated scenarios (S1140). In some embodiments, a scenario with a total burden value (i.e., the sum of burden values for all action items) that fails to meet certain inclusion criteria is eliminated from the ordered list (S1150), or is not included in the ordered list (i.e., the generated list may be limited to include those scenarios that meet predetermined inclusion criteria).

In one example embodiment, the inclusion or exclusion criteria for a simulated scenario may be based on burden value comparisons, such that scenarios with burden values beyond a threshold (e.g., higher or lower than a certain limit) are selected. In some example embodiments, the list may not be initially ordered according to the burden values associated with the plurality of simulated scenarios. Instead, the list may be ordered or reordered after the elimination or inclusion process of unsuitable scenarios is concluded. Thus, an ordered list of N scenarios that meet a threshold burden value is generated.

The ordered list of N scenarios may be reordered or updated, in one or more embodiments, in accordance with the value of the simulated scores for the respective scenarios included in the list. For example, the simulated score for a first scenario may be compared against the target score 902 to determine whether following the suggested action items in the first scenario will achieve or come close to achieving the target score 902 in the target time duration 904. For example, it may be determined whether the simulated score for a first simulated scenario from among the N scenarios is within an acceptable distance D to the target score (S1160). If not, the first simulated scenario may be eliminated from the list and on to the next simulated scenario.

As shown in FIG. 10C, in at least one example embodiment, the N scenarios are processed until a final list of M scenarios is generated, where the final list includes the scenarios that both meet the burden threshold and are within an acceptable distance D to the target score, where D is preferably a number equal or greater than zero. However, a negative value for D is perceivable (and may be acceptable depending on implementation), if no simulated scenario is able to achieve a simulated score that is equal or a higher than the target score 902.

The M scenarios or their respective action items may be presented in a hierarchical order in UI 900 (S1170). Alternatively, the related data may be processed for the purpose of determining suitability or eligibility of an individual or entity. Depending on implementation, the M scenarios may be ordered, sorted, or filtered according to a hierarchical scheme corresponding to a total score calculated for a simulated scenario based on:
burden values B₁ through Bₘ associated with the respective M scenarios,
distance values D₁ through Dₘ associated with the respective M scenarios,
plan duration d₁ through dₘ associated with the respective M scenarios, or
a combination of the above.

In some implementations, the total score may be determined according to a burden algorithm based on a set of parameters, such as the total monthly payment amount (e.g., x₁), the target time duration (e.g., x₂), the total revolving credit limit increase amounts (e.g., x₃), and other factors such as the user's current total revolving credit limit, plan duration, etc. Based on the burden algorithm, a burden score may be assigned to one or more (or each) of the simulated scenarios 1 through M.

In one example embodiment, the total burden score y for a scenario may be determined using the following algorithm, where x₁ is the total monthly payment amount; x₂ is the duration of the payment plan in months; x₃ is the total revolving credit limit increase amount; L is the individual's or entity's current total revolving credit limit; and d is equal to a first value (e.g., 1) if the plan duration is less than or equal to the target time duration 904; and d is equal to a second value (e.g., 0) if the plan duration is greater than the target time duration 904:

$$y = {x}_{1} + ( 5 d + 1000 ( 1 - d ) ) {x}_{2} + 3000 ( \frac{{x}_{3}}{L} )$$

As such, depending on implementation, the ordered list of simulated scenarios or action items is organized based on how closely a scenario may satisfy the target score 902 in the target time duration 904. In some implementations, scenarios with suggested longer durations than the target time duration 904 are deprioritized by a burden calculation or a scoring algorithm. In some implementations, the ordered list of simulated scenarios or action items is organized or arranged for display (e.g., via UI 900) in a hierarchical fashion (e.g., based on a score ranking) according to the determined scores for the M scenarios.

In accordance with one or more embodiments, the burden score associated with a scenario may be determined based on a heuristic, where the heuristic is utilized to hierarchically arrange unexecuted scenarios according to their burden values or other metric. This implementation reduces the number of iterations (e.g., scenario executions) needed to identify the most suitable scenarios by determining, for example, the burden associated with the simulated scenario constructs prior to execution. As such, this approach reduces the amount of processing and storage resources because a large number of simulated scenarios need not be executed, making the computing system more efficient in terms of time and resource allocation.

In an example embodiment in which burden is determined in advance of the execution of the simulated scenarios, the burden is calculated based on the scenario and data aggregated from CRA 806 or database 808 (and desirably inputs provided by a user). Notably, in this embodiment, to determine the burden value there is no need to execute the simulated scenarios to calculate any results (e.g., a simulated credit score). Based on the calculated burden values, the plurality of scenarios are hierarchically ranked or eliminated from consideration. In other words, instead of constructing and executing a large number of simulated scenarios, the constructed scenarios are first ranked according to burden value. Depending on implementation, the burden value of a constructed scenario is determined based on a burden heuristic that takes into account known credit information about an entity without requiring the calculation of a simulated score.

For example, consider simulated scenarios constructed with a 9-month paydown duration or a 6-month paydown duration. All other parameters being equal, a scenario construct with a 9-month paydown duration has a higher burden value than a scenario construct with a 6-month paydown duration. Based on the same logic, a scenario construct that entails a $4,000 paydown amount would have a higher burden value than a scenario construct that entails a $2,000 paydown amount. Accordingly, the simulated scenarios constructed with smaller paydown durations or paydown amounts may be ranked higher. In some embodiments, the lower ranked scenarios are eliminated or not executed, if the execution of the higher ranked scenarios results in an acceptable target score.

In accordance with some aspects, beginning with the least burdensome scenario, one or more constructed scenarios are executed to generate a simulated score based on which it may be determined whether the target score is reasonably achievable by, for example, user-provided target time duration. If so, no additional scenarios need to be executed (e.g., no more credit scores need to be calculated for the remaining simulated scenarios). If not, the next least burdensome scenario is executed, and so on, until a scenario is found that generates a simulated score that reasonably achieves the target score by the target time duration (e.g., if the simulated score for the scenario falls into an acceptable range or distance).

A decision tree may be utilized to determine the order in which the scenarios are simulated. For example, if credit data indicates existence of unpaid balances, balance pay-down scenarios are simulated by the ML model according to rules or instructions in a decision tree. The decision tree may or may not be embedded in an application that uses the ML model for scenario simulation. Otherwise, scenario constructs are simulated that don't include balance pay-down. In one example, a decision tree may be used to rank a plurality of simulated scenario constructs, where a ML model simulates the scenarios based on, without limitation, monthly paydown dollar amount, paydown time duration, amount of new credit, capacity to make large payments or obtain new credit, and the weight of new credit actions.

Simulated scenario constructs may be executed according to sets of rules or instructions implemented in a decision tree. For example, the rules of the decision tree may dictate: if a simulated scenario calls for paying down $1000, then if the credit report shows both revolving balances and installment balances, then dynamically construct scenarios which apply the $1000 in various predetermined proportions to revolving accounts and installment accounts. Or, if only revolving balances are indicated in the credit report, then dynamically apply the $1000 to the revolving accounts. Or, if only installment balances are indicated in the credit report, apply the $1000 to the installment accounts.

In some implementations, the target duration is incorporated in the score calculation for a scenario, such that scenarios with a duration longer than the target duration are simulated (only) if no scenarios at or below the target duration may reach the target score 902. In some implementations, if no scenario is able to meet or exceed the target score 902, then the UI 900 generates an alert or indication that CSP 812 is unable to simulate or find a scenario with planning statements or action items that satisfy the target score 902.

Notably, in some implementations, only action items that are applicable to an individual's or entity's credit profile are generated. For example, for an individual or entity with no revolving accounts, scenarios that require payments towards revolving accounts are not simulated (or are excluded). The examples below illustrate how a list of potential scenarios with respective action items may be simulated by CSP 812 (e.g., using ML model 100) based on a total burden value determined for the different scenarios.

In this first example, a starting current score of 660 is assumed with a total revolving balance of $2,000; no installment loan balances; a target score of 700; and a target duration of 6 months. CSP 812 generates a list of potential scenarios (Plans A through Z) with action items having total plan burdens and a simulated scores as provided below:
Plan A:
   Pay down $50 (2.5%) of revolving account balances−burden+50
   0 months duration−burden+0
      Total Plan burden: 50, based on the revolving payments. A duration of 0 adds no burden.
      Result: simulated score 660 (no improvement)
Plan B:
   Pay down $50 (2.5%) of revolving balances per month, for 3 months−burden+50
   Pay bills on time for 3 months−burden+15
      Total Plan burden: 65. A duration of 3 months adds burden compared to a duration of 0.
      Result: simulated score 665 (+5 points score improvement, but not meeting target score)
Plan C:
   Pay down $50 (2.5%) of revolving balances per month, for 6 months−burden+50
   Pay bills on time for 6 months−burden+30
      Total Plan burden: 80.
      Result: simulated score 670 (+10 points score improvement,
      not meeting target score)
Plan D:
   Pay down $100 (5%) of revolving account balances−burden+100
   0 months duration-burden+0
      Total Plan burden: 100. The higher monthly payment amount compared to A-C adds more burden.
      Result: simulated score 665 (+5 points, not meeting target score)
Plan E:
   Pay down $100 (5%) of revolving balances per month, for 3 months−burden+100
   Pay bills on time for 3 months−burden+15
      Total Plan burden: 115
      Result: simulated score 670 (+10 points, not meeting target
      score)
Plan F:
   Pay down $100 (5%) of revolving balances per month, for 6 months−burden+100
   Pay bills on time for 6 months−burden+30
      Total Plan burden: 130
      Result: simulated score 680 (+20 points, not meeting target score, but within an acceptable distance D from the target score)
. . .
Plan N:
   Pay down $50 (2.5%) of revolving account balances per month, for 3 months−burden+50
   Apply for and receive a revolving credit limit increase of $1000−burden+240
   Pay bills on time for 3 months−burden+15
   Total Plan burden: 305. Applying for and receiving a credit limit increase adds significant burden.
   Result: simulated score 660 (no improvement)
Plan O:
   Pay down $300 (15%) of revolving balances per month, for 3 months−burden+300
   Pay bills on time for 3 months−burden+15
      Total Plan burden: 315. Higher monthly payments compared to N add more burden.
      Result: simulated score 690 (+30 points, not meeting target score, but within an acceptable distance D from the target score)
Plan P:
   Pay down $300 (15%) of revolving balances per month, for 6 months−burden+300
   Pay bills on time for 6 months−burden+30
      Total Plan burden: 330
      Result: simulated score 705 (+45 points, exceeding target score).
. . .
Plan Z:
   Pay down $150 (7.5%) of revolving balances per month, for 12 months−burden+150
   Pay bills on time for 12 months−burden+12000
      Total Plan burden: 12150.
      Result: The duration of 12 months drastically increases the burden, as it exceeds the user-selected target duration of 6 months. Longer durations are deprioritized by the burden calculation but remain part of the hierarchy so they may be checked if the target can't be met within the desired duration. In this example, there is no need to generate the simulated score, because a less burdensome plan already reached the target.

Accordingly, in the above example, plans F, O, and P may be presented in an order in accordance with a hierarchy determined based on values associated with the calculated burden, the distance D between the simulated score and the target score 902, or some other criteria. The hierarchy, for example, may be determined first based on the total burden associated with a scenario, and then based on the simulated score for a scenario. In the above example, plans F, O, P may be thus ordered with Plan F being presented as the top choice. In an alternative embodiment, the simulated plans may be ordered from highest to lowest simulated score as long as the plans are associated with a total burden value that meets a threshold. In the above example, Plan P with the highest simulated score may be presented as the top choice.

Referring to FIG. 10D, in some implementations, the different scenarios and their respective action items are generated, organized, arranged, filtered, or sorted according to process 1150 based on an efficiency value rating. As shown, in one example embodiment, once the target time duration and target score are received (S1151), a plurality of scenarios and their respective action items are generated (S1152). Thereafter, simulated scores are determined for the different simulated scenarios according to their respective set of action items (S1153).

Depending on implementation, once a simulated score (e.g., credit score) is determined for a simulated scenario based on the suggested action items in that scenario, the suggested action items are evaluated based on a set of predetermined criteria. For example, for a first simulated scenario, if the simulated credit score is less than the target score 902 or the duration for achieving the simulated credit score is greater than the target time duration 904, then the first simulated scenario is eliminated. Or, if a second simulated scenario fails to result in a simulated credit score that satisfies the target score 902 needed for successfully opening a new credit account, then the second scenario is eliminated (S1154).

In accordance with one or more aspects, for simulated scenarios that satisfy the predetermined criteria, a monthly payment plan may be determined based on the target time duration 904. An efficiency factor may then be determined for the remaining (non-eliminated) simulated scenarios (S1155). The efficiency factor, depending on implementation, may be determined based on a set of values including, without limitation, x representing the total simulated monthly payment amount, s representing the simulated credit score for a scenario, and a representing the current credit score:

yₙ=(s−a)/x

Referring back to FIG. 10D, once efficiency factors for the respective remaining simulated scenarios are determined, the scenarios with the most suitable (e.g., highest) efficiency factors may be presented in a hierarchical manner via UI 900 (S1156). In some implementations, the scenario with the most suitable (e.g., highest) efficiency factor is provided at the most prominent portion (e.g., top) of a hierarchy arrangement (e.g., list). In some implementations, in the event multiple scenarios are tied with respect to efficiency, the scenario with the shortest time duration is presented at the top of the hierarchy.

The example below illustrates selecting or arranging one or more most suitable scenarios based on the efficiency factor. In this second example, a starting current score of 640 is assumed with a total revolving balance of $5,000, and no installment loan balance. As shown, multiple scenarios (Plans A through G) are simulated based on the provided target score and target time duration:
Plan A:
   Pay down $500 (10%) of revolving account balances
   0 months duration
      Result: simulated score 655 (+15 points)
Plan B:
   Pay down $750 (15%) of revolving balances per month, for 3 months
   Pay bills on time for 3 months
      Result: simulated score 700 (+60 points)
Plan C:
   Pay down $400 (8%) of revolving balances per month, for 12 months
   Pay bills on time for 12 months
      Result: simulated score 760 (+120 points)
Plan D:
   Pay down $250 (5%) of revolving balances per month, for 6 months
   Establish 1 new revolving account
   Pay bills on time for 6 months
      Result: simulated score 670 (+30 points)
Plan E:
   Pay down $1000 (20%) of revolving balances per month, for 3 months
   Apply for and receive a revolving credit limit increase of $2500
   Pay bills on time for 3 months
      Result: simulated score 740 (+100 points)
Plan F:
   Pay down $1000 (20%) of revolving balances per month, for 3 months
   Pay bills on time for 3 months
      Result: simulated score 725 (+85 points)
Plan G:
   Pay down $4000 (80%) of revolving balances
   0 months duration
      Result: simulated score 730 (+90 points)

The simulated scenarios and their respective action items may be evaluated based on a set of criteria. For example, simulated scenarios or action items that result in a simulated credit score greater or equal to the target score 902 are included in a finalist queue, while scenarios that result in a smaller simulated credit score are eliminated. As illustrated in this second example, assuming a target score of 700 and a target duration of 6 months, then plans B, C, E, F, and G are included in the finalist queue.

In accordance with one or more aspects, simulated scenarios that have a duration longer than the target duration (e.g., 6 months) may be eliminated from the finalist queue. In some embodiments, elimination stops if the elimination process results in the finalist queue including less than a threshold number (e.g., zero) of simulated scenarios. For example, the elimination process cannot result in an empty finalist queue, in certain embodiments. In this second example, Plan C may thus be removed. Further, simulated scenarios that satisfy the target score 902 but require applying for or opening new credit may be eliminated. Thus, Plan E may be also removed. Accordingly, plans B, F, and G remain in the finalist queue after the elimination of plans C and E.

Ultimately, monthly payment amounts are generated for the scenarios in the finalist queue (e.g., plans B, F, and G in this second example). An efficiency factor may be calculated for the respective scenarios or plans in accordance with the efficiency algorithm y=(s−a)/x noted earlier:
Plan B: +60 points, $750 monthly payment, factor=0.08
Plan F: +85 points, $1000 monthly payment, factor=0.085
Plan G: +90 points, $4000 monthly payment, factor=0.0225

The simulated scenario or plan with the most suitable efficiency factor (e.g., the greatest efficiency) may be presented at the top of the hierarchical arrangement in UI 900. Since Plan F has the highest factor with 0.085, Plan F and its respective action items will be selected and presented at the top of the hierarchy in UI 900, optionally followed by other simulated plans B and G, for example.

Below is another example illustrating determining a series of most suitable action items to present in a hierarchical order based on the efficiency factor. In this third example, a starting current score of 600 is assumed with total revolving balances of $5,000, and no installment loan balances. As shown below, multiple scenarios (e.g., plans A through G) are simulated based on the received target time duration 904 and target score 902. Simulated credit scores are determined for the multiple simulated scenarios:
Plan A:
   Pay down $500 (10%) of revolving account balances
   0 months duration
      Result: simulated score 615 (+15 points)
Plan B:
   Pay down $750 (15%) of revolving balances per month, for 3 months
   Pay bills on time for 3 months
      Result: simulated score 660 (+60 points)
Plan C:
   Pay down $400 (8%) of revolving balances per month, for 12 months
   Pay bills on time for 12 months
      Result: simulated score 720 (+120 points)
Plan D:
   Pay down $250 (5%) of revolving balances per month, for 6 months
   Establish 1 new revolving account
   Pay bills on time for 6 months
      Result: simulated score 630 (+30 points)
Plan E:
   Pay down $1000 (20%) of revolving balances per month, for 3 months
   Apply for and receive a revolving credit limit increase of $2500
   Pay bills on time for 3 months
      Result: simulated score 700 (+100 points)
Plan F:
   Pay down $1000 (20%) of revolving balances per month, for 3 months
   Pay bills on time for 3 months
      Result: simulated score 685 (+85 points)
Plan G:
   Pay down $4000 (80%) of revolving balances
   0 months duration
      Result: simulated score 690 (+90 points)

The simulated scenarios are evaluated based on a set of plan criteria. For example, scenarios (and their respective action items) that result in a simulated score greater or equal to the target score 902 are retained, while scenarios (and their respective action items) that result in a simulated score less than a threshold are filtered out or eliminated.

In this third example, assuming a target score of 660 and a target duration of 3 months, plans B, C, E, F, and G are included in a finalist queue. In some aspects, simulated scenarios that have a duration longer than the target duration may be eliminated from the finalist queue. Elimination may stop if, for example, the elimination process results in the finalist queue including less than a threshold number of simulated scenarios. In this example, plans that have a simulated duration longer than the target duration 904 (e.g. greater than 3 months) are eliminated. Plan C is thus eliminated. Further, plans that require applying for or opening new credit are eliminated. Thus, Plan E is eliminated. Ultimately, a monthly payment amount is generated for the corresponding remaining scenarios (e.g., plans B, F, and G) and an efficiency factor is calculated for each scenario:
Plan B: +60 points, $750 monthly payment, factor=0.08
Plan F: +85 points, $1000 monthly payment, factor=0.085
Plan G: +90 points, $4000 monthly payment, factor=0.0225

Plan F has the highest efficiency factor of 0.085 and is presented at the highest hierarchical order with other remaining plans B and G to follow, for example, in accordance with their respective efficiency factors.

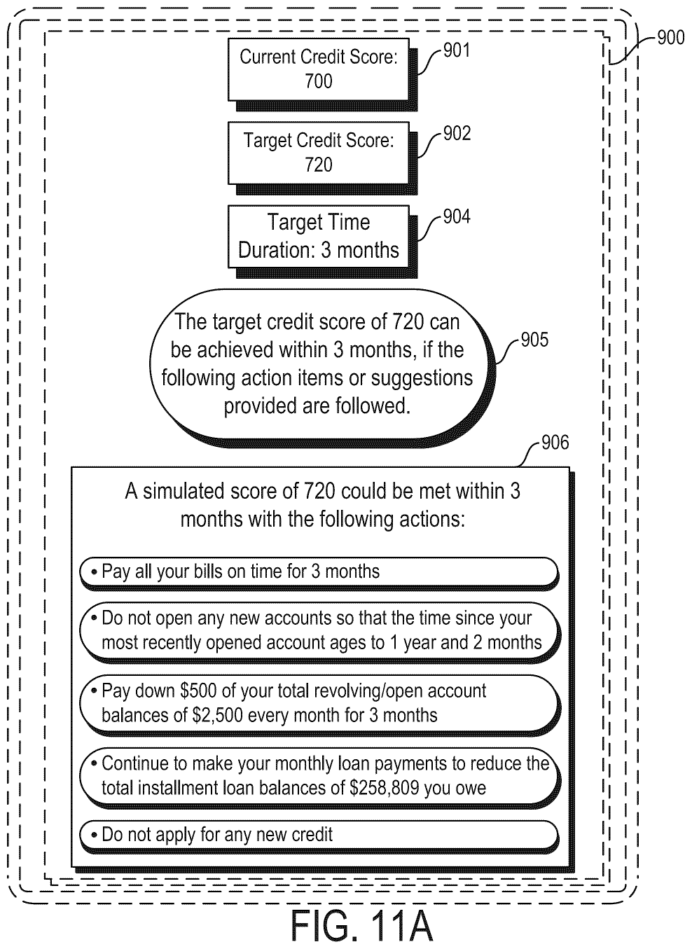

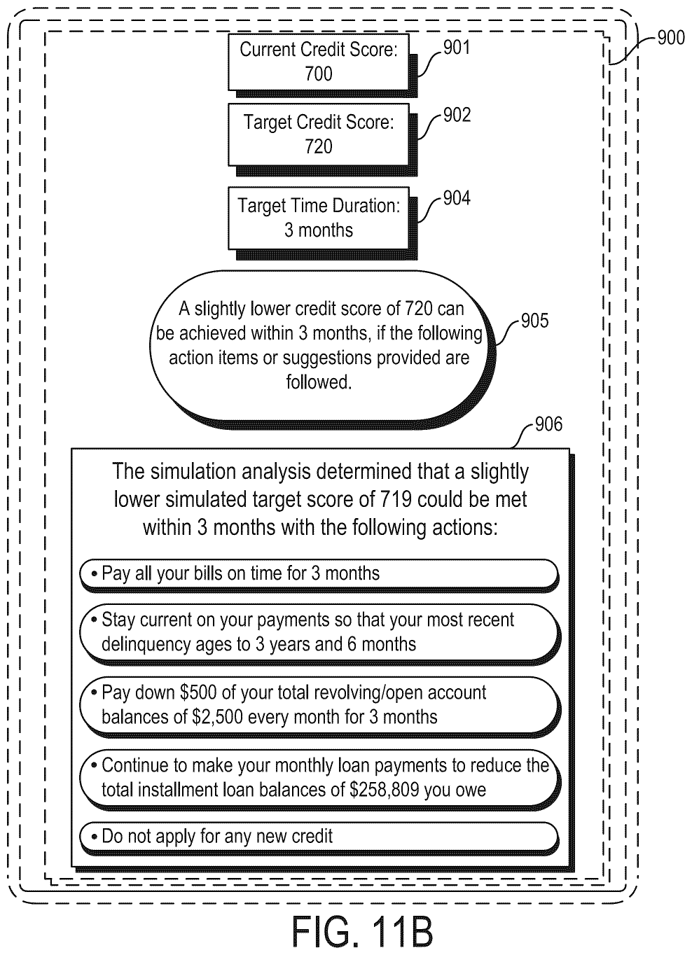

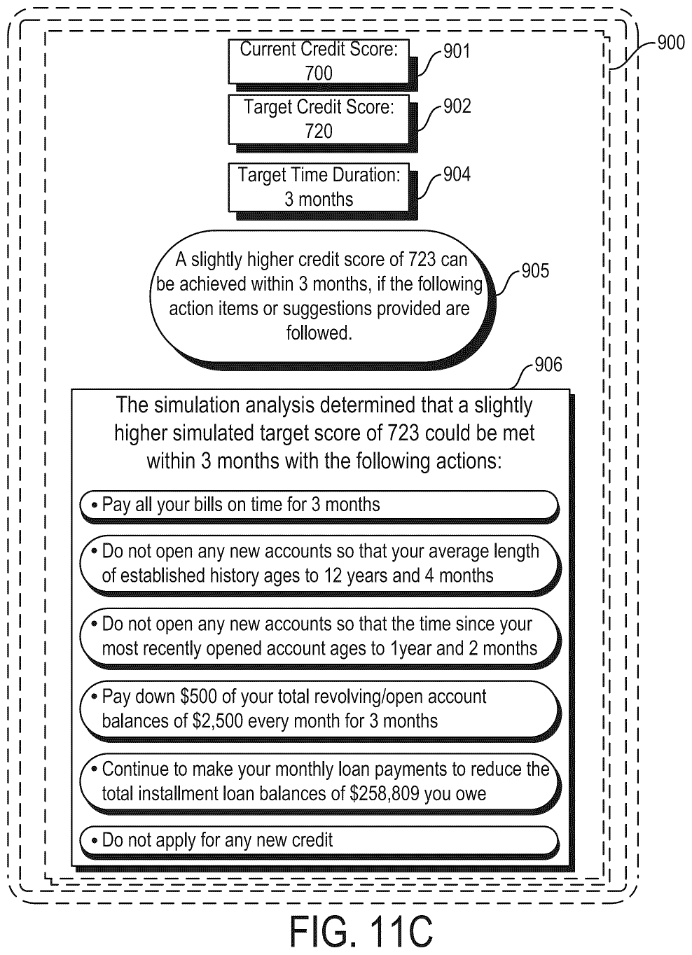

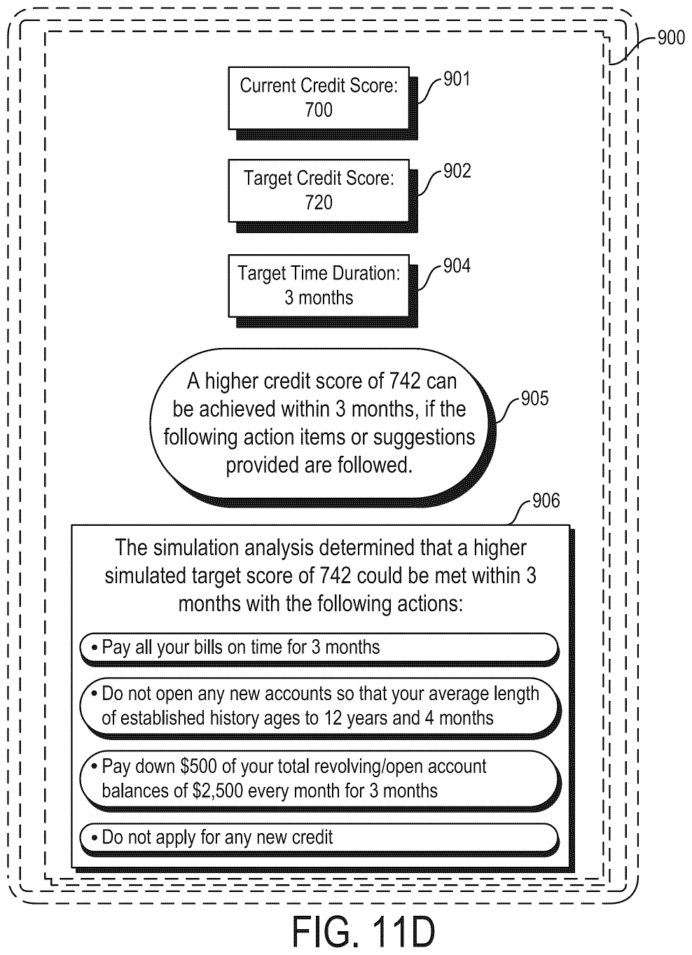

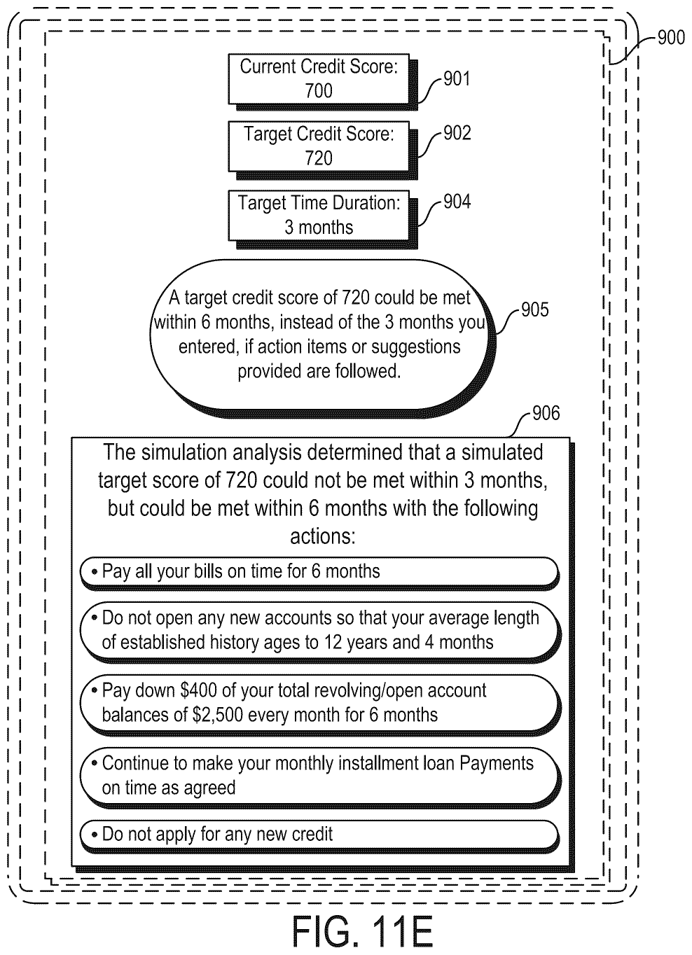

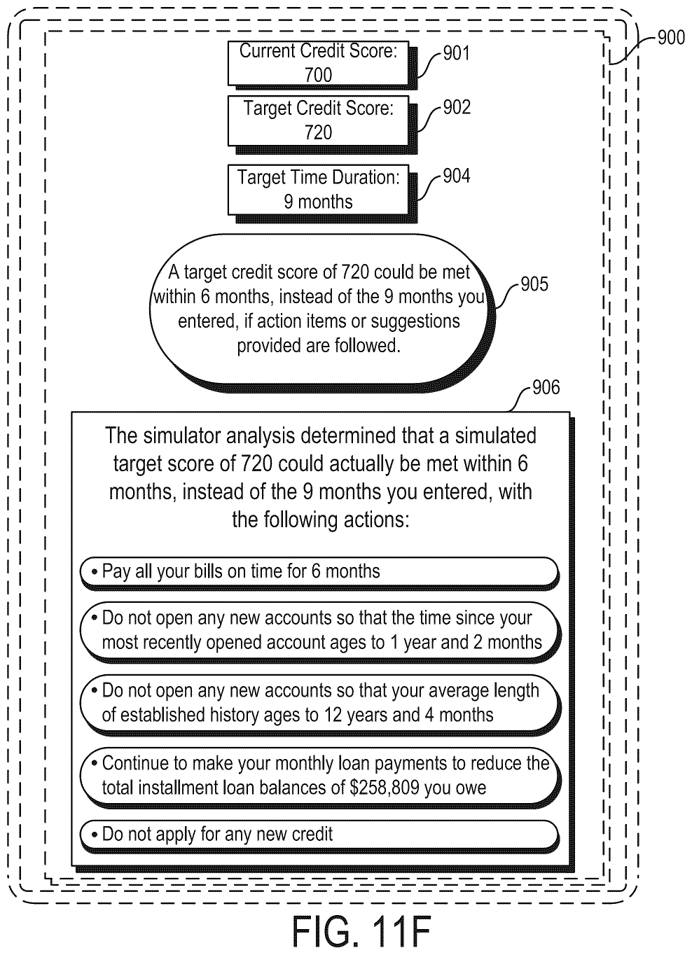

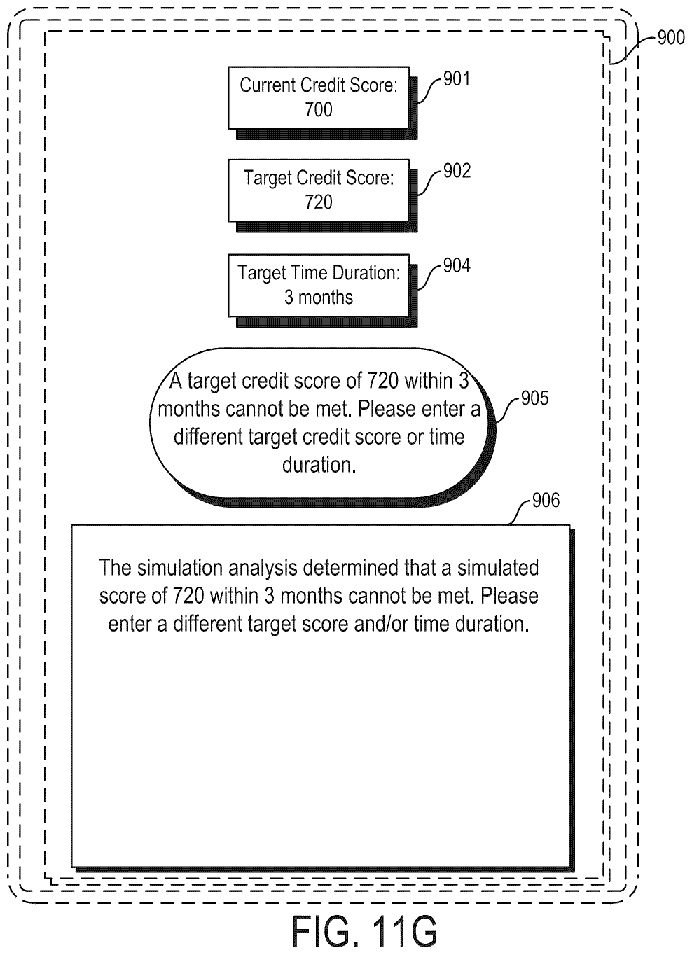

Referring to FIGS. 11A through 11G, example embodiments are illustrated in which a variety of different scenarios may be presented to an individual or entity seeking to enhance or repair his or her score. In some implementations, an eligible simulation scenario hierarchy may be determined based on which suggested actions or informative guidelines may be displayed on how to improve the current score. The scenario hierarchy may also rank the simulated scenarios based on a combination of wait time and score improvement. Next, a corresponding set of planning statements and action items for the highest-ranking scenario (i.e., the most practical and favorable scenario for the specific user) may be generated for display. An example set of suggestions may include the following:
Pay bills on time for “x” months (this may be suggested, for example, if there is a balance >=$1 on any tradeline).
Do not open new tradeline for “x” months (this may be suggested, for example, if there is no balance on any tradeline).
Pay down “$y” of your total revolving/open account balances of “$y” every month for “x” months.
Increase your card limit by “$y”.

In the above examples, the suggested action or option for paying down card balances may be based on range of pay down percentages logic at the attribute levels (i.e., not exact dollar amounts) to mask exposure of the underlying proprietary credit scoring algorithm.

The suggestion to increase limits may be enacted based on a line increase strategy according to a score range as provided in the following set of examples:
If Score <670, suggest no line increase
If Score 670-689, suggest $500 line increase
If Score 690-719, suggest $1,000 line increase
If Score 720-749, suggest $1,500 line increase
If Score 750-799, suggest $2,000 line increase
If Score 800+, suggest $3,000 line increase

In some implementations, a user may run one or more target score scenarios to generate one or more simulated target scores. In some implementations, these scenarios may be run on ML model 100. If the simulated target score for a scenario is less than a predetermined value, CSP 812 may not generate any feedback or suggestions as output. CSP 812 may automatically evaluate whether the target score entered by the user may be met in a shorter duration. If so, the output may include the simulated target score based on a shorter time duration. For example, if the user entered a desired target score of 700 to be achieved in 6 months, CSP 812 may determine that the desired target score of 700 may be met in a shorter time (e.g., in 3 months).

In one aspect, the CSP 812 may determine that a shorter timeline may be possible for achieving a target score, but may determine that the burden to reach that goal on the user may be unduly burdensome. For example, CSP 812 may determine that a target score of 700 may be achieved in 6 months as the user had requested, but the parameters for achieving the goal in the identified amount of time may require the user to pay down a certain debt at twice the monthly rate as currently scheduled. In such a scenario, CSP 812 may suggest a 9 or 12 month timeline with a payment schedule that is more realistic for the particular user.

Accordingly, in some scenarios, if the CSP 812 determines the target score entered cannot be met in the time duration selected, the CSP 812 may automatically evaluate if that target score may be met within a longer time duration (e.g., 15 months). Depending on implementation, if the calculated time duration for achieving the target credit goal is longer than a predetermined time duration (e.g., 24 months) then CSP 812 may not include any suggestions for that scenario. For example, if the user input indicates target score of 700 in 6 months and the analysis by the CSA 810 determines that the target score of 700 may be met in 26 months, suggestions for that scenario are not provided to the user.

In some implementations, N possible suggestions or action items (e.g., 6 action items) for improving a score may be provided to the user by the CSP 812. The following list is a non-limiting example of items that may be generated for viewing by a user, in accordance with various aspects:
Current score calculated for an individual or entity or user who desires to improve his score at the time the user provides user information to CSP 812
Target score (entered by the user)
Target time duration to improve score (entered by the user)
Simulated target score (calculated by CSP 812 based on credit history and credit information available for the user, and target score and target time duration data entered by the user)
Simulated time duration (calculated by CSP 812 factoring the simulated target score based on credit history and credit information available for the user, and target score and target time duration data entered by the user)
Planning statement
Action items or suggestions

The following are examples of content that may be generated in a planning statements:
Score is too low or inadequate for generating a plan.
The target score entered must be yyy points or higher than your current score and cannot exceed the maximum score of xyz.
A target score of zzz could be met within x months, if action items or suggestions provided are followed.
A slightly lower target score of zzz could be achieved within x months, if action items or suggestions provided are followed.
A higher target score of zzz could be met within x months, if action items or suggestions provided are followed.
A target score of zzz could be met within y months, instead of the x months you entered, if action items or suggestions provided are followed.
A target score of zzz could not be met within x months you entered, but could be met within y months, if action items or suggestions provided are followed.
A target score of zzz within x months cannot be met. Please enter a different target score or time duration.

Example action factors or suggestions that may be provided so that the user may attain the desired target score within the desired target timeframe may include:
Pay all your bills on time for “x” months
Continue to pay all your bills on time
Stay current on your payments so that your most recent delinquency is “x” years and “x” months
Stay current on your payments so that your most recent delinquency is deleted from your credit report
Do not open any new accounts, so that your average length of established history becomes x years and y months
Do not open any new accounts, so that the time since your most recently opened account becomes x years and y months
Pay down “$y” of your total revolving/open account balances every month for “x” months
Increase your card limit by “$y”
Do not apply for any new credit
Continue to make your monthly loan payments (e.g., mortgage, auto, personal loans and other reported installment loan balances) to reduce the total installment loan balances of $xxx,xxx you owe.

In some traditional decision management systems, generic recommendations may be generated based on a general understanding of assessment rating schemes and how different factors and risks would generally impact any user. Other systems may provide a single generic recommendation without accounting for alternative scenarios or user goals. Based on the measurements, in some embodiments, ML model 100 may be used in decision management systems (e.g., CSP 812) to determine and generation action items for a user, such as generating a set of tailored planning statements and action items that satisfy certain parameters.

In some implementations, depending on a user's standing score, CSP 812 may or may not suggest to the user to request a credit limit increase. For example, for a first user with a poor score, CSP 812 may not suggest a credit limit increase of any amount because such person would not be expected to qualify for a credit limit increase of any amount. For a second user with a fair score, CSP 812 may generate an action item suggesting a request to increase the credit limit by an amount of $500, where such action would contribute to the user's ability to achieve the target score in the target time duration. For a third user with an excellent score, CSP 812 may generate an action item to request an increase in credit limit by an amount of $2000, where such action would contribute to the user's ability to achieve even a higher target score in a shorter time duration.

In certain implementations, individual data points (e.g., tradelines) may be grouped and characterized by an ML model 100. The characteristics may be weighted by ML model 100 to result in a score. The weights may be based on many factors, such as the presence/absence of other characteristics, the relative value of one set of some characteristics as compared to others, etc. The score may be analyzed and computed at different levels of aggregation. For example, at the characteristics level, the score may be analyzed by examining the expected score changes based on changes in the aggregate. The score may also be analyzed at the tradeline level by examining expected score changes based on changes to a specific data point or tradeline.

For instance, ML model 100 may provide a recommendation whether paying down $500 in credit card balance may impact a score. At the characteristics level, ML model 100 may use summarized information from the original score calculation, such as revolving utilization across all tradelines of a certain percentage and total balances across all trade lines of a certain value. ML model 100 may make modifications at the characteristic level that may be used to calculate the simulated score, including making some assumptions and approximations. For example, the total balance across all tradelines (if this is or were a scored characteristic) could have a simulated value of Y−500. The overall revolving utilization could have a simulated value of X % reduction. Based on the summarized information, the characteristics level allows ML model 100 to make these determinations.

At the tradeline level, the user's score could be exposed to the user and provide the user an opportunity to select which tradelines to apply the $500 credit card balance onto. In some implementations, ML model 100 may use an expert approach or multiple approaches to determine the best allocation of the $500. Based on these allocations, the model characteristics and simulated score may be re-calculated. As such, the simulation score may provide an accurate result based on the modified detailed data (which is a reflection on the user's score after taking intended actions).

As provided earlier, in some embodiments, ML model 100 may be utilized to control or restrict transmission of malicious data packets to different end points in a network. A data packet includes bits of data that are compartmentalized into different portions. These different compartments or portions of the data packet are designated to carry specific information referred to as header and payload, for example. The payload typically includes digitized content intended for consumption by the recipient (e.g., a text message, an email, music, etc.). The header may include, without limitation, information such as the sender's and recipient's addresses, the communication protocol used (e.g., TCP), and sequence numbers to ensure data security and proper reassembly on the receiving end.

Malicious actors, such as cyber criminals, may attempt to corrupt or manipulate the content of a data packet in order to compromise the security of data packets and to gain unauthorized access to content being transmitted. A corrupted or malicious data packet may include a secret encryption key in the header used to encrypt the data within the packet's payload. This allows attackers to send malicious content in network traffic by encrypting the content with a key only known to the attacker. In certain embodiments, malicious data packets may be identified and assigned a score by way of analyzing traffic patterns to identify suspicious behavior and indications of anomalous activity. Reputation-based analysis or filtering may be used, for example, to block or drop data packets from known malicious IP addresses or domains when an assessment rating (e.g., a reputation score) associated with an origination or destination source fails to meet certain thresholds.

In one or more embodiments, CSP 812 may receive or determine an assessment rating (e.g., safety score) for current network traffic. If the safety score does not meet a threshold or predetermined range, CSP 812 may utilize ML model 100 to simulate a plurality of scenarios for improving the safety score. A simulated scenario may suggest certain planning statements or action items (e.g., block traffic from an identified malicious source, drop data packets addressed to identified malicious destinations, eliminate data packets with header size greater than a threshold, etc.). Enforcing or implementing the suggested action items may help achieve a better safety score (e.g., target score) for the network by a certain target time period in the future (e.g., target time duration).

The implementation or enforcing the suggested action items in the simulated scenarios may be associated with a certain cost. For example, the cost associated with implementing the suggested action items in a first scenario may be X, the cost associated with implementing the action items in a second scenario may be Y, and so on. The cost associated with each scenario may be determined based on the inventive concepts disclosed herein according to, for example, a burden value or efficiency value and the disclosed processes to simulate and select the most suitable scenario for among a plurality of simulated scenarios.

For example, CSP 812 may utilize a decision tree 1000 to select or arrange in a hierarchical order, the most suitable scenarios and corresponding action items for managing network traffic. In this manner, CSP 812 may be utilized to achieve a target safety rating for network traffic by a target time duration. To accomplish this, action items in a selected scenario (e.g., the least costly scenario) may be implemented to block, eliminate, or otherwise manage data packets in network traffic. CSP 812 or a data packeting monitoring system may utilize suggested action items to manage or achieve an optimal level of data transmission over the network by, for example, eliminating certain data packets to minimize the transmission of corrupt data packets and achieve a more desirable safety score.

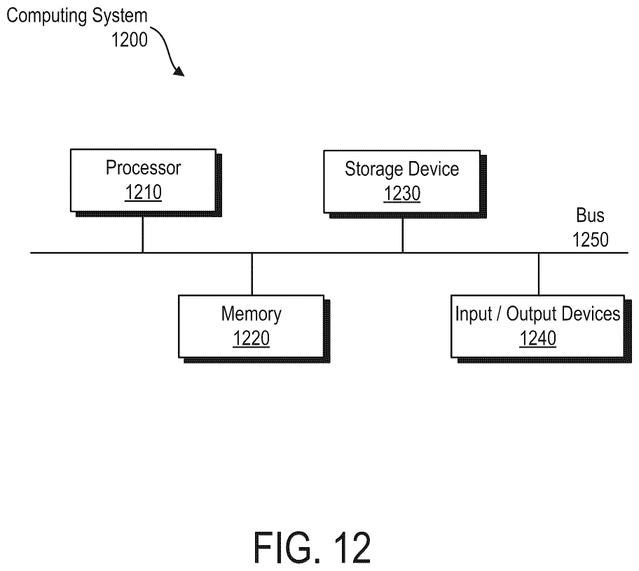

Referring to FIG. 12, a block diagram illustrating a computing apparatus 1200 consistent with one or more embodiments is provided. The computing apparatus 1200 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 12, the computing apparatus 1200 may include a processor 1210, a memory 1220, a storage device 1230, and input/output devices 1240. The processor 1210, the memory 1220, the storage device 1230, and the input/output devices 1240 may be interconnected via a system bus 1250. The processor 1210 is capable of processing instructions for execution within the computing apparatus 1200. Such executed instructions may implement one or more components of, for example, a cloud platform. In some implementations of the current subject matter, the processor 1210 may be a single-threaded processor. Alternately, the processor 1210 may be a multi-threaded processor. The processor 1210 is capable of processing instructions stored in the memory 1220 and/or on the storage device 1230 to display graphical information for a user interface provided via the input/output device 1240.

The memory 1220 is a computer readable medium such as volatile or non-volatile that stores information within the computing apparatus 1200. The memory 1220 may store data structures representing configuration object databases, for example. The storage device 1230 is capable of providing persistent storage for the computing apparatus 1200. The storage device 1230 may be a floppy disk device, a hard disk device, an optical disk device, or a tape device, or other suitable persistent storage means. The input/output device 1240 provides input/output operations for the computing apparatus 1200. In some implementations of the current subject matter, the input/output device 1240 includes a keyboard and/or pointing device. In various implementations, the input/output device 1240 includes a display unit for displaying graphical user interfaces.

According to some implementations of the current subject matter, the input/output device 1240 may provide input/output operations for a network device. For example, the input/output device 1240 may include Ethernet ports or other networking ports to communicate with one or more wired and/or wireless networks (e.g., a local area network (LAN), a wide area network (WAN), the Internet).

In some implementations of the current subject matter, the computing apparatus 1200 may be used to execute various interactive computer software applications that may be used for organization, analysis and/or storage of data in various (e.g., tabular) format (e.g., Microsoft Excel®, and/or any other type of software). Alternatively, the computing apparatus 1200 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing products and/or functionalities. Upon activation within the applications, the functionalities may be used to generate the user interface provided via the input/output device 1240. The user interface may be generated and presented to a user by the computing apparatus 1200 (e.g., on a computer screen monitor, etc.).

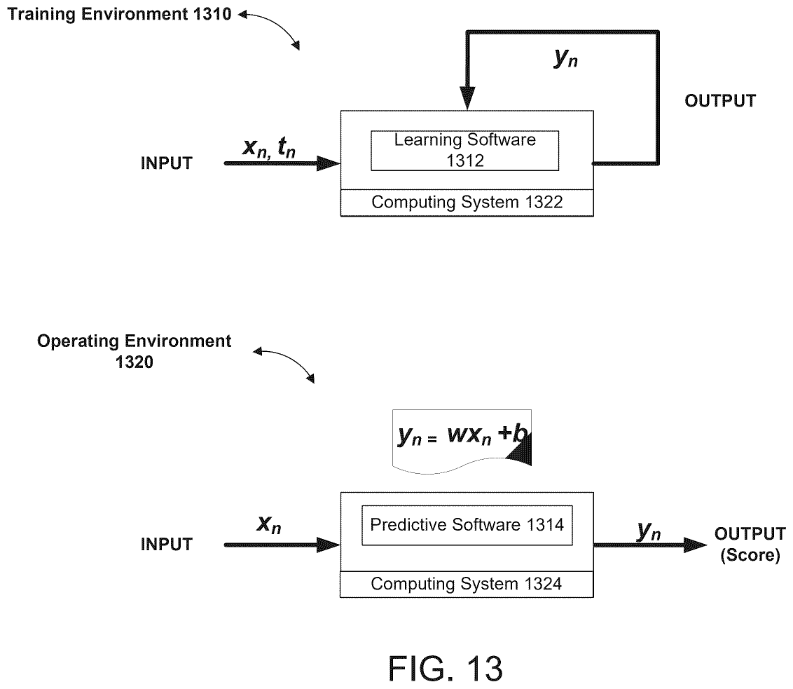

Referring to FIG. 13, example training environment 1310 and operating environment 1320 are illustrated. As shown, a computing system 1322 and training data may be used to train learning software 1312. Computing system 1322 may be a general-purpose computer, for example, or any other suitable computing or processing platform. Learning software 1312 may be a machine learning or self-learning software that receives event-related input data. In the training phase, an input event may be known as belonging to a certain category (e.g., fraudulent or non-fraudulent) such that the corresponding input data may be tagged or labeled as such.

It is noteworthy that while certain example embodiments may be implemented in a direct classification (e.g., hard classification) environment, other possible embodiments may be directed to score-based classification in a probabilistic sense (e.g., soft classification) as well as regression. Accordingly, learning software 1312 may process the input data associated with a target event, without paying attention to the labels (i.e., blindly), and may categorize the target event according to an initial set of weights (w) and biases (b) associated with the input data. When the output is generated (i.e., when the event is classified by learning software 1312), the result may be checked against the associated labels to determine how accurately learning software 1312 is classifying the events.

In the initial stages of the learning phase, the categorization may be based on randomly assigned weights and biases, and therefore highly inaccurate. However, learning software 1312 may be trained based on certain incentives or disincentives (e.g., a calculated loss function) to adjust the manner in which the provided input is classified. The adjustment may be implemented by way of adjusting weights and biases associated with the input data. Through multiple iterations and adjustments, the internal state of learning software 1312 may be continually updated to a point where a satisfactory predictive state is reached (i.e., when learning software 1312 starts to more accurately classify the inputted events at or beyond an acceptable threshold).

In the operating environment 1320, predictive software 1314 may be utilized to process event data provided as input. It is noteworthy that, in the operating phase, input data is unlabeled because the classification (e.g., the fraudulent nature) of events being processed is unknown to the model. Software 1314 may generate an output that classifies a target event as, for example, belonging to a first class (e.g., the fraudulent category), based on fitting the corresponding event data into the first class according to the training data received during the training phase. In accordance with example embodiments, predictive software 1314 may be a trained version of learning software 1312 and may be executed over computing system 1324 or another suitable computing system or computing infrastructure to generate one or more outputs, classifications or scores that may be used to make determinations or predictions.

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”. Further the use of the term “or” should not be construed as an “exclusive or” unless otherwise specified as such.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure.

Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

A portion of the disclosure of this patent document may contain material, which is subject to copyright protection. The owner has no objection to facsimile reproduction by any one of the patent document or the patent disclosure, as it appears in the Patent and Trademark Office patent file or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

1. A computer-implemented method comprising:
displaying, on a display screen, a graphically implemented interactive menu listing a plurality of user interface fields, wherein the plurality of user interface fields receive a set of user-define parameters from a first entity including at least a target assessment rating and a target time duration;
generating, based on at least the target assessment rating and the target time duration, a first weight matrix by using a first artificial neural network (ANN) associated with an aggregate dataset, wherein the first weight matrix includes a set of weighted score factors related to the first entity;
simulating, by the first ANN, one or more scenarios for a set of action items by evaluating an analytic decision tree using the first weight matrix;
determining, based on the simulation, a first scenario associated with a first planning statement and a first set of corresponding action items, and a second scenario associated with a second planning statement and a second set of corresponding action items, wherein the first scenario achieves one or more favorable outcomes, in terms of achieving at least a first assessment rating within a first timeline, over the second scenario;
ranking the first scenario in a more elevated hierarchical position than the second scenario based on the one or more favorable outcomes; and
generating, for display on the display screen, at least the first planning statement and the first set of corresponding action items based on the elevated hierarchical position of the first scenario.

2. The method of claim 1 further comprising:
generating, for display on the display screen, the second planning statement and the second set of corresponding action items based on a less elevated hierarchical position of the second scenario, wherein the second set of action items is more burdensome than the first set of action items, the first set of action items being presented in advance of the second set of action items on the display screen.

3. The method of claim 1, wherein one or more action items in the first set of action items represents one or more actions that may be taken to achieve a target assessment score by a suggested time duration associated with the target time duration, the one or more actions being associated with at least one of the weighted score factors.

4. The method of claim 3, wherein the suggested time duration matches the target time duration.

5. The method of claim 3, wherein the suggested time duration is shorter than the target time duration, in response to determining that the target assessment rating is achievable in a shorter timeframe than the target time duration.

6. The method of claim 3, wherein the suggested time duration is longer than the target time duration, in response to determining that the target assessment rating is unachievable in the target time duration.

7. The method of claim 1, wherein a less desirable target assessment rating than the target assessment rating is suggested in the planning statement, in response to determining that the less desirable target assessment rating, instead of the target assessment rating, is achievable in approximately the target time duration.

8. A primary computing device comprising a display screen, the primary computing device configured for:
displaying on the display screen, using a processor, a graphically implemented interactive menu listing a plurality of user interface fields,
at least one user interface field displayed on the display screen being directly reachable from the interactive menu to receive a set of user-defined parameters, including at least one of a target score and a target time duration,
wherein the interactive menu, using the processor, displays a limited list of data including value of at least one of the target score or the target time duration in one or more user interface fields,
the target score or the target time duration utilized by the processor to execute an application to enable displaying a set of action items in a hierarchical order,
wherein the interactive menu is displayed while the application is in a first state associated with receiving the set of user-defined parameters,
the application, using the processor, utilizing an analytic decision tree to simulate one or more scenarios for a set of action items that improve a score at a first time towards the target score by the target time duration, in response to the processor determining that the target score or the target time duration are within an acceptable range,
in response to the application being executed by the processor, the application accessing data associated with a first entity, the data generated based on a set of weighted score factors related to the first entity's creditworthiness,
generating, using the processor, the interactive menu including at least one of a first field displaying a first score, a second field for receiving and displaying the target score, and a third field for receiving and displaying the target time duration,
the target time duration indicating a period of time starting from the first time until a second time after the first time for achieving the target score, as the first score changes over time based on changes in values of one or more score factors in the set of weighted score factors;
the application, in response to receiving the target score and the target time duration via the interactive menu, simulating using the processor a plurality of scenarios that satisfy the target score within the target time duration,
a first scenario associated with a first plurality of possible planning statements and a first set of action items,
a second scenario associated with a second plurality of possible planning statements and a second set of action items;
the application, in response to determining that the first scenario achieves a more favorable result in terms of a combination of wait time and score improvement over the second scenario, orderly ranking the first scenario in a more elevated hierarchical position than the second scenario using the processor; and
generating for display on the display screen, using the processor, the first plurality of possible planning statements and the first set of action items based on the elevated hierarchical position of the first scenario, wherein the first set of action items is less burdensome than the second set of action items,
generating for display on the display screen, using the processor, the second plurality of possible planning statements and the second set of action items based on a less elevated hierarchical position of the second scenario, wherein the second set of action items is more burdensome than the first set of action items,
the first set of action items being presented in advance of the second set of action items on the display screen;
one or more action items in the first set of action items representing one or more actions that may be taken to achieve the target score by a suggested time duration associated with the target time duration, the one or more actions being associated with at least one of the weighted score factors,
wherein a less desirable target score than the target score is suggested in the planning statement, in response to the processor determining that the less desirable target score, instead of the target score, is achievable in approximately the target time duration.

9. The system of claim 8, wherein the suggested time duration matches the target time duration.

10. The system of claim 8, wherein the suggested time duration is shorter than the target time duration, in response to determining that the target score is achievable in a shorter timeframe than the target time duration.

11. The system of claim 8, wherein the suggested time duration is longer than the target time duration, in response to determining that the target score is unachievable in the target time duration.

12. A computer-implemented method comprising:
receiving, by an application specific integrated circuit (ASIC) for a first artificial neural network (ANN), a set of user-define parameters from a first entity including at least a target assessment rating and a target time duration;
generating, based on at least the target assessment rating and the target time duration, a first weight matrix by using the first ANN, the first weight matrix includes a set of weighted score factors related to the first entity;
simulating, by using a first hidden node associated with the first ANN, one or more scenarios for a set of action items by evaluating an analytic decision tree using the first weight matrix;
determining, by using the ASIC and based on the simulation, a first scenario associated with a first planning statement and a first set of corresponding action items, and a second scenario associated with a second planning statement and a second set of corresponding action items, wherein the first scenario achieves one or more favorable outcomes, in terms of achieving at least a first assessment rating within a first timeline, over the second scenario;
ranking the first scenario in a more elevated hierarchical position than the second scenario based on the one or more favorable outcomes; and
generating, by using the ASIC and responsive to the ranking, the first planning statement and the first set of corresponding action items based on the elevated hierarchical position of the first scenario.

13. The method of claim 12 further comprising:
generating, by using the ASIC and responsive to the ranking, the second planning statement and the second set of corresponding action items based on a less elevated hierarchical position of the second scenario, wherein the second set of action items is more burdensome than the first set of action items.

14. The method of claim 12, wherein one or more action items in the first set of action items represents one or more actions that may be taken to achieve a target assessment score by a suggested time duration associated with the target time duration, the one or more actions being associated with at least one of the weighted score factors.

15. The method of claim 14, wherein the suggested time duration matches the target time duration.

16. The method of claim 14, wherein the suggested time duration is shorter than the target time duration, in response to determining that the target assessment rating is achievable in a shorter timeframe than the target time duration.

17. The method of claim 14, wherein the suggested time duration is longer than the target time duration, in response to determining that the target assessment rating is unachievable in the target time duration.

18. The method of claim 12, wherein a less desirable target assessment rating than the target assessment rating is suggested in the planning statement, in response to determining that the less desirable target assessment rating, instead of the target assessment rating, is achievable in approximately the target time duration.

19. A method of rearranging a plurality of icons on a graphical user interface (GUI) of a computer system, wherein the plurality of icons are associated with a plurality of simulated scenarios for achieving a target assessment rating by a target time duration, the method comprising:
receiving, via a GUI, a selection to organize the plurality of icons based on a specific criteria, wherein the specific criteria is an amount of burden determined for a simulated scenario;
determining, by a processor, the amount of burden for at least two or more of the plurality of scenarios, wherein the amount of burden is based on one or more action items suggested by a simulated scenario for best achieving the target assessment rating by the target time duration or a time within a threshold distance from the target time duration;
automatically moving the icons associated with the plurality of simulated scenarios to positions on the GUI according to a hierarchical arrangement determined based on the respective amounts of burden determined for the plurality of simulated scenarios.

20. A method of rearranging a plurality of icons on a graphical user interface (GUI) of a computer system, wherein the plurality of icons are associated with a plurality of simulated scenarios for achieving a target assessment rating by a target time duration, the method comprising:
receiving, via a GUI, a selection to organize the plurality of icons based on a specific criteria, wherein the specific criteria is a preference value or an amount of efficiency determined for a simulated scenario;
determining, by a processor, the preference value or the amount of efficiency for at least two or more of the plurality of scenarios, wherein the preference value or the amount of efficiency is based on one or more action items suggested by a simulated scenario achieving the target assessment rating by the target time duration;
automatically moving the icons associated with the plurality of simulated scenarios to positions on the GUI according to a hierarchical arrangement determined based on the respective preference values or amounts of efficiency determined for the plurality of simulated scenarios.

21. A computer-implemented method comprising:
receiving data characterizing a set of user-define parameters from a first entity including at least a target assessment rating and a target time duration;
simulating, based on the received data, a plurality of scenario constructs, wherein at least a first scenario construct from among the plurality of scenario constructs is associated with a first set of action items and at least a second scenario construct from among the plurality of scenario constructs is associated with a second set of action items;
determining a first burden value for the first scenario construct and a second burden value for the second scenario construct;
determining suitability of the plurality of scenarios based on the burden values respectively associated with the plurality of scenario constructs;
providing one or more scenario constructs in the hierarchical order based on the respective burden values.

22. A computer-implemented method comprising:
receiving data characterizing a set of user-define parameters from a first entity including at least a target assessment rating and a target time duration;
simulating, based on the received data, a plurality of scenarios, wherein at least a first scenario from among the plurality of scenarios is associated with a first set of action items and at least a second scenario from among the plurality of scenarios is associated with a second set of action items;
determining a first simulated score and a first burden value for the first scenario and a second simulated score and a second burden value for the second scenario;
determining suitability of the plurality of scenarios based on the simulated score and the burden values respectively associated with the plurality of scenarios;
determining a distance between the target assessment rating and the simulated score corresponding to a set of action items;
providing one or more scenarios that include a distance that satisfies a predefined threshold, wherein the one or more scenarios are provided in a hierarchical order based on the burden values.

23. A computer-implemented method comprising:
receiving data characterizing a set of user-define parameters from a first entity including at least a target assessment rating and a target time duration;
simulating, based on the received data, one or more scenarios, wherein each of the one or more scenarios is associated with a set of action items;
determining a total score for each set of action items for each scenario;
removing, using an analytic decision tree, any scenario from the one or more scenarios that includes a total score that fails to satisfy a set of predetermined criteria;
determining an efficiency factor associated with each of the one or more remaining scenarios; and
providing the remaining one or more scenarios in a hierarchical position based on the efficiency factor.
